(19) United States
(12) Patent Application Publication
(10) Pub. No.: US 2012/0060295 A1
(43) Pub. Date: Mar. 15, 2012

(54) DECREASED SHEAR GELATINOUS CUSHION

(75) Inventors: Roland E. Flick, Elma, NY (US); David M. Robbins, Orchard Park, NY (US)

(73) Assignee: GAYMAR INDUSTRIES, INC., Orchard Park, NY (US)

(21) Appl. No.: 12/881,244

(22) Filed: Sep. 14, 2010

(51) Int. Cl. B68G 5/00; B29C 39/00

(52) U.S. Cl. 5/655.5; 264/331.11

(57) ABSTRACT

A gelatinous elastomeric cushion having decreased shear forces applied to the patient by altering the gelatinous elastomeric configuration in certain areas. For example, the decreased gelatinous elastomeric material does not have secondary walls align with each other. Alternatively, the cushion has different gelatinous configurations in different sections of the cushion to intentionally elongate the walls to decrease the shear pressure applied to the patient.

### FIELD OF INVENTION

The invention is directed to a gelatinous elastomeric cushion positioned over a bed frame, in particular a gatch bed frame.

### BACKGROUND OF THE INVENTION

A gatch bed frame is commonly defined as a hospital bed with a frame in two or three movable sections equipped with mechanical spring parts that permit raising the head end, foot end, and/or middle as required. An example of a three-part gatch bed is set forth in Stryker Corporation's U.S. Pat. No. 7,690,059 that issued on Apr. 6, 2010, which is hereby incorporated by reference in its entirety. This application is not directed to the bed frame or the gatch bed frame. Instead this invention is, directed to a gelatinous elastomeric cushion that can be positioned on the gatch bed without increasing the shear pressure applied to a patient lying thereon.

In U.S. Pat. No. 7,690,059; Stryker wrote, “As illustrated in FIGS. [29 to 34], for example; the deck support 700 generally comprises a head or Fowler section 702, toward the head-end 1002 of the gatch bed 1001, which is pivotally coupled to a seat/thigh or Knee Gatch section 704, itself pivotally coupled to a foot section 706, toward the foot-end 1040 of the bed 1001. Each of the head, seat/thigh and foot sections 702, 704, and 706 are configured to articulate the deck support 700 between a plurality of positions, such as for example, a substantially horizontal position (FIGS. [29 to 30 and 34]), a legs-down position (FIG. [31]), a substantially seated position (FIGS. [23 and 33]), etc.”

Stryker further wrote, “the head section 702 can be rotated about pivot 708 such that a head-end 710 of the head section is raised relative to a foot-end 712; . . . the seat section 704 can be similarly rotated about pivot 718 such that its foot-end is raised relative to its head-end; [and] the foot section 706 can be similarly rotated about pivot 728 such that its foot-end is lowered relative to its head-end.” The mechanics of how the gatch bed operates is set forth in U.S. Pat. No. 7,690,059. For this application, we need to know that a mattress material is positioned over the gatch bed's head, seat/thigh and foot sections 702, 704, and 706 and corresponding pivot sections.

### Gelatinous Elastomeric Composition

What is a gelatinous elastomeric material? Currently, a preferred gelatinous elastomeric material comprises an A-B-A triblock copolymer and a plasticizer oil. The “A” component in the A-B-A triblock copolymer is a crystalline polymer like polystyrene and the “B” component is an elastomer polymer like poly(ethylene-propylene) to form a SEPS polymer; poly(ethylene-butadyene) to form a SEBS polymer, or hydrogenated poly(isoprene+butadiene) to form a SEEPS polymer. However, to appreciate gelatinous elastomeric's evolution, we disclose the following various gelatinous elastomeric compositions.

In U.S. Pat. No. 3,485,787, which is hereby incorporated by reference, Haefele et al. disclose oil-extended triblock copolymers of the general configuration A-B-A, wherein A is an alkenyl aromatic hydrocarbon polymer block and B is a conjugated diene hydrocarbon polymer block. The '787 patent explains that alkenyl aromatic hydrocarbons are useful as the A blocks and that the B portion can be any four to ten carbon conjugated diene.

Broad average molecular weight ranges are disclosed for each component—“A” having an average molecular weight of about 4,000 to 115,000 and “B” having an average molecular weight of about 20,000 to 450,000. The amount of extending oil ranges from 5 to 100 parts by weight based on 100 parts by weight block copolymer.

In U.S. Pat. No. 3,676,387, which is hereby incorporated by reference, Lindlof discloses an oil-based elastomer which is five to thirty weight percent triblock copolymer of the general configuration A-B-A and seventy to ninety-five percent non-aromatic paraffinic oil. The patent defines compound “A” as a glassy or resinous non-elastomeric thermoplastic polymer block with a glass transition temperature above room temperature, having an average molecular weight of between about 2,000 and 100,000 and which is relatively incompatible with the elastomeric polymer block B. Compound “B” is defined as an elastomeric polymer block of a conjugated diene, the average molecular weight being about 15,000 and about 1,000,000 and having a glass transition temperature considerably below that of the A blocks. The '387 patent also states that A:B weight ratios of 10:90 to 50:50 are useful. The oil weight percentage of the oil-extended elastomers of that patent, based on the combined weight of oil and elastomer, is in the range of 70% to 95%.

Similar elastomeric materials are described in U.S. Pat. No. 3,827,999, which is hereby incorporated by reference. In that patent, Crossland discloses block copolymers extended in 70 to 98 weight percent oil. The use of monoalkenylarene end blocks which are block polymerized with a conjugated diene is preferred. The average molecular weight range of the monoalkenylarene blocks used in Crossland's material is 5,000 to 75,000. The average molecular weight range of the conjugated diene blocks used in that material is 25,000 to 250,000.

A styrene-ethylene butylene-styrene (SEBS) block copolymer, which has the general configuration A-B-A, is described in U.S. Pat. No. 4,176,240, issued to Sabia, which is hereby incorporated by reference. Sabia made a solid, handleable gel material comprising 5 to 10 weight percent SEBS, 87 to 93 weight percent naphthenic oil and 0 to 6 weight percent polyethylene, wherein all weight percentages are based upon the total weight of the material. Sabia further wrote that during experimentation, styrene-isoprene-styrene (SIS) was used as a substitute for SEBS.

In U.S. Pat. No. 4,259,540, incorporated herein by reference, Sabia discloses list of useful components for making compositions similar to those of the '240 patent was broadened. For example, in addition to naphthenic oils, the '540 patent describes use of paraffinic oils and mixtures of naphthenic and paraffinic oils. Similarly, the styrene to rubber ratio (A:B) range of the SEBS was increased from about 0.4 to approximately 0.2 to 0.5 (i.e., 20:80 to 50:50) and is stated as preferably being about 0.4. In addition, a fourth element, isopropyl phenyl-phenyl phosphate, was added to the material to inhibit oil synersis.

In U.S. Pat. No. 4,351,913, which is hereby incorporated by reference, Patel discloses a material comprising a triblock copolymer of the general configuration A-B-A, chosen from SEBS, 7IS and styrene-butadiene-styrene (SBS), and paraffinic or naphthenic mineral oil. In addition, glass or ceramic microspheres and/or an additive may be used to make that material.

In U.S. Pat. No. 4,369,284, which is hereby incorporated by reference, Chen discloses an oil-extended elastomer composition that includes about 6 to about 25 weight percent SEBS and about 75 to about 94 weight percent of a plasticizing oil. The SEBS component of Chen's material has a styrene to rubber (A:B) ratio within the range of between 31:69 and 40:60. Chen discloses a gelatinous elastomeric material having (a) 100 parts by weight of a SEBS; and (b) from about 300 to about 1,600 parts by weight of a plasticizing oil.

In U.S. Pat. No. 4,618,213, which is hereby incorporated by reference, Chen describes a material similar to that disclosed in Chen's '284 patent. In the '213 patent, Chen changed the average molecular weight range for plasticizing oils useful in the material, this time by stating that plasticizing oils having molecular weights of less than about 200 and greater than about 700 would be useful in his material.

In U.S. Pat. No. 5,262,468, which is hereby incorporated by reference, Chen describes a different variation of the gelatinous elastomeric material that broadened the A:B ratio range useful in his materials to about 20:80 or less to about 40:60 or higher.

In U.S. Pat. No. 5,508,334, which is hereby incorporated by reference, Chen disclosed another gelatinous elastomeric material that includes the addition of a “minor amount” of various polymers to the material. In the '334 patent, Chen's gel is a mixture of (i) 100 parts by weight of a high viscosity poly(styrene-ethylene-butylene-styrene) triblock copolymer, (ii) from about 300 to about 1600 parts by weight of a plasticizing oil; and (iii) a minor amount of one or more homopolymers or copolymers.

In U.S. Pat. Nos. 5,239,723 and 5,475,890, which are each hereby incorporated by reference, Chen, in each reference, discloses elastomeric gelatinous materials wherein the A:B ratio range of the SEBS triblock copolymer used in that material—20:80 to 40:60—is much broader than the SEBS A:B ratio range of the materials disclosed in Chen's other patents: U.S. Pat. Nos. 4,369,284 and 4,618,213.

In U.S. Pat. No. 5,334,646, which is hereby incorporated by reference, Chen claims an article of manufacture made from essentially the same material as that disclosed in Chen's U.S. Pat. No. 5,262,468. Chen's list of articles of manufacture includes such things as a crutch cushion, a cervical pillow, a bed wedge pillow, a leg rest cushion, a neck cushion, a mattress, a bed pad, an elbow pad, a wheelchair cushion, an orthopedic shoe sole, or a splint, a sling, or a brace cushion for the hand, wrist, finger, forearm, knee, leg, clavicle, shoulder, foot, ankle, neck, back or rib. In addition, the '646 patent mentions that the material may be, cast onto open cell substrates.

In U.S. Pat. No. 5,336,708, which is hereby incorporated by reference, Chen discloses a layered composite which includes layers of Chen's previously described materials physically interlocked with layers of other materials. The composite may contain more than one layer of Chen's materials, each layer having the same or different rigidities. The remaining layers are selected from the group consisting of foam, plastic, fabric, metal, concrete, wood, glass, ceramics, synthetic resin, synthetic fibers or refractory materials.

In U.S. Pat. Nos. 4,432,607 and 4,492,428, both of which are hereby incorporated by reference, Levy discloses oil-extended triblock copolymers (i.e., gels). Those patents describe materials made from styrene block copolymers and a plasticizing agent. The '607 and '428 patents disclose materials which include styrene-ethylene butylene-styrene (SEBS). Specifically, according to the '607 and '428 patents, Levy used KRATON® G1560 and KRATON® G1652, both manufactured by Shell Chemical Company of Houston, Tex., as the rubber component of his material ('607, col. 5, line 51; '428, col. 6, line 12). Both patents also state that Shell Chemical's KRATON® G1651 could be used as the rubber. The copolymers useful in those materials have a styrene to rubber (A:B) ratio of 0.2 to 0.5, and preferably of about 0.4. The plasticizer used in the materials of the '607 and '428 patents includes either naphthenic or paraffinic mineral oils or mixtures thereof. Optionally, the plasticizer may contain wax. The '607 and '428 patents state that, in the case of a single-layer or outer-layer coating, microcrystalline wax is preferred as a plasticizer.

In U.S. Pat. No. 4,497,538, which is hereby incorporated by reference, Patel discloses a composition which includes SEBS block copolymers, petrolatum and polyethylene. According to the examples in the patent; SEBS makes up from 0.5 to 15 percent of the material. SEBS having a styrene to rubber (A:B) ratio of 0.39 to 0.41 is useful for purposes of that patent. Specifically, Patel prefers Shell Chemical's KRATON® G1650 and G1652. Petrolatum containing no more than about 15% oil, as determined by ASTM D 721, is preferred. Polyethylene makes up from about 1 to 15% of the material. Polyethylenes that are considered useful in that material have a molecular weight in the 1,000 to 10,000 range and a specific gravity of greater than 0.90.

In U.S. Pat. No. 4,509,821, which is hereby incorporated by reference, Stenger discloses a gelatinous elastomeric material comprising a plasticizing oil, SEBS and a linear polyethylene wax. The plasticizing oil, which makes up from 85 to 91% of the material, is either naphthenic oil, paraffinic oil or a mixture thereof. The SEBS, which makes up from 5 to 10% of the material, has a styrene to rubber (A:B) ratio of from approximately 0.2 to 0.5, preferably of about 0.4. Polyethylene wax having an average molecular weight in the range of about 1,000 to 1,500 makes up the remaining 2 to 8% of the material.

In U.S. Pat. No. 4,709,982, which is hereby incorporated by reference, Corne et al. disclose a gelled oil filling compound which includes a block copolymer having a molecular weight in the 200,000 to 2,000,000 range and a hydrocarbon oil having an aromatic content of 12% or less. Corne's preferred block copolymer is Shell Chemical's KRATON® G1651, an SEBS copolymer.

In U.S. Pat. No. 4,716,183, which is hereby incorporated by reference, Gamarra et al. disclose oil-extended styrene-diene block copolymers which include a cross-linked multifunctional coupling agent. In particular, the patent's examples all discuss the use of Shell Chemical's KRATON® G1650, KRATON® G1651, or a mixture thereof. The copolymers make up from about 2 to about 30 weight percent of the material, based upon the total weight of the material.

In U.S. Pat. No. 4,798,853, which is hereby incorporated by reference, Handlin, Jr. describes a gel filling composition for cables which includes two to fifteen weight percent SEBS and 85 to 98 weight percent naphthenic or paraffinic oil or solvent having an aromatic content of up to 25 weight percent of the oil/solvent weight, the weight percentages of SEBS and oil being based upon the total composition weight. Most of Handlin's examples utilize Shell Chemical's KRATON® G1652. Oils/solvents having an aromatic content of about 15% are also preferred.

In U.S. Pat. Nos. 4,942,270 and 5,149,736, both of which are incorporated herein by reference, Gamarra disclose gel compositions for use in cable sealing apparatus which are “nonmeltable” (i.e., begin to degrade, decompose or break down in some manner before they reach a temperature at which the composition will melt and become pourable). The compositions of those patents each include an SEBS triblock copolymer and oil. One of Gamarra's preferred SEBSs has a high molecular weight, particularly in the 250,000 to 280,000 range, and a styrene to rubber ratio (A:B) of 33:67. The SEBS sold by Shell Chemical as KRATON® G1651 was used for the patent's examples. Oils which are useful in the compositions have molecular weights in the range of about 400 to about 2,500, and preferably in the range of 450 to 1,500. Oil makes up from 70 to 98 weight percent of the composition, preferably from 75 to 95 weight percent. Gamarra prefers that the SEBS and oil are melt blended under high shear.

In U.S. Pat. No. 5,331,036, which is hereby incorporated by reference, Kang et al. describe elastomer compositions which include copolymer compositions of 1,3-conjugated dienes and aromatic vinyl compounds having a weight average molecular weight of greater than about 1,000,000 and oil. Copolymers suitable for use in that material include, among others, midblocks (B) of 1,3-butadiene, 2,3-dimethyl-1,3 butadiene and 1,3 hexadiene. Kang prefers using styrene-butadiene-styrene block copolymers. The oil makes up from about 23 to about 75 weight percent of the composition, preferably greater than about 44 weight percent.

In August 1995, Kuraray prepared a brochure about its SEEPS material that it developed in 1993. In that brochure, Kuraray wrote that a SEEPS polymer provided higher tensile strength, moderate elongation, and better oil absorbency in relation to its SEBS polymer in the following chart.

SEP

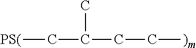

Good Flowability
SEPS

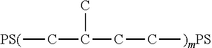

No Crystallization
Better Low Temperature Properties
High Elongation
SEBS
Random copolymer block

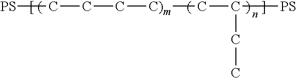

Moderate Tensile Strength
SEEPS
Random copolymer block

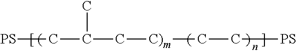

High Tensile Strength
Moderate Elongation
Better Oil Absorbency

Moreover, Kuraray alluded that a SEPS polymer, a SEBS polymer and a SEEPS polymer were useful materials to alter polymeric compositions. Kuraray essentially reported that a SEPS polymer, a SEBS polymer and a SEEPS polymer are each interchangeable to provide certain desired polymeric properties.

In U.S. Pat. No. 5,994,450; Pearce disclosed a gelatinous elastomeric material comprising “a triblock copolymer elastomer of the configuration A-B-A and having a weight average molecular weight of about 300,000 or above, block A being a non-elastomeric polymer and block B being an elastomeric polymer, said A-B-A triblock copolymer having no solution viscosity at 20% solids in 80% toluene at 25° [sic] Celcius as it remains a solid under those conditions, and a plasticizer combined with said triblock copolymer elastomer to form a visco-elastic material, said plasticizer being compatible with said B block.” See claim 65. That invention was recently deemed unpatentable during a reexamination. The elastomer used in the invention is preferably an ultra high molecular weight polystyrene-hydrogenated poly(isoprene+butadiene)-polystyrene, such as those sold under the brand names SEPTON 4045, SEPTON 4055 and SEPTON 4077 by Kuraray, an ultra high molecular weight polystyrene-hydrogenated polyisoprene-polystyrene such as the elastomers made by Kuraray and sold as SEPTON 2005 and SEPTON 2006, or an ultra high molecular weight polystyrene-hydrogenated polybutadiene-polystyrene, such as that sold as SEPTON 8006 by Kuraray. High to very high molecular weight polystyrene-hydrogenated poly(isoprene+butadiene)-polystyrene elastomers, such as that sold under the trade name SEPTON 4033 by Kuraray, are also useful in some embodiments of the present invention because they are easier to process than the preferred ultra high molecular weight elastomers due to their effect on the melt viscosity of the material. The plasticizer can be processing oils such as paraffinic and naphthenic petroleum oils, highly refined aromatic-free or low aromaticity paraffinic and naphthenic food and technical grade white petroleum mineral oils, and synthetic liquid oligomers of polybutene, polypropene, polyterpene, etc., and others. The synthetic series process oils are oligomers which are permanently fluid liquid non-olefins, isoparaffins or paraffins. Many such oils are known and commercially available. Examples of representative commercially available oils include Amoco® polybutenes, hydrogenated polybutenes and polybutenes with epoxide functionality at one end of the polybutene polymer. Examples of such Amoco polybutenes include: L-14 (320 Mₙ), L-50 (420 Mₙ), L-100 (460 Mₙ), H-15 (560 Mₙ), H-25 (610 Mₙ), H-35 (660 Mₙ), H-50 (750 Mₙ), H-100 (920 Mₙ), H-300 (1290 Mₙ), L-14E (27-37 cst @ 100° F. Viscosity), L-300E (635-690 cst @ 210° F. Viscosity), Actipol E6 (365 Mₙ), E16 (973 Mₙ), E23 (1433 Mₙ) and the like. Examples of various commercially available oils include: Bayol, Bemol, American, Blandol, Drakeol, Ervol, Gloria, Kaydol, Litetek, Marcol, Parol, Peneteck, Primol, Protol, Sontex, and the like.” The gelatinous elastomeric material can also include gas pockets; microspheres; a melt viscosity modifier selected from the group consisting of hydrocarbon resins, transpolyoctenylene rubber, castor oil, linseed oil, non-ultra high molecular weight thermoplastic rubbers, surfactants, dispersants, and emulsifiers; a flame retardant selected from the group consisting of halogenated flame retardants, non-halogenated flame retardants, and volatile, non-oxygen gas forming chemicals; a tensile strength modifier selected from the group consisting of mid block B associating hydrocarbon resins, non-end block A solvating hydrocarbon resins, and particulate reinforcers; a tack modifier selected from the group consisting of surfactants, dispersants, and emulsifiers or hydrocarbon resins, polyisobutylene, and butyl rubber; and/or a foam facilitator selected from the group consisting of polyisobutylene, butyl rubber, surfactants, emulsifiers and dispersants; a plasticizer bleed modifier selected from the group consisting of hydrocarbon resins, elastomeric diblock copolymers, polyisobutylene, butyl rubber, and transpolyoctenylene rubber.

### Examples Manufacturing Process for Gel Materials

Now that we know various gelatinous elastomeric compositions, we will briefly discuss how the gelatinous elastomeric compositions are made. We revert to Pearce's U.S. Pat. Nos. 7,060,213 and 6,413,458. In those patents, Pearce wrote:

A method for manufacturing a gelatinous elastomer article comprising the steps of: (a) selecting a plasticizer, (b) selecting a triblock copolymer of the general configuration A-B-A that includes SEEPS [or other A-B-A triblock copolymers may be used individually or in combination with other polymers], (c) premixing said plastizer and said copolymer, (d) using a compounding screw to compound said premixed plasticizer and copolymer, (e) receiving compounded gelatinous elastomer from said screw, (f) permitting said compounded gelatinous elastomer to cool, (g) cutting said cooled compounded gelatinous elastomer into smaller pieces, (h) storing said gelatinous elastomer pieces for a period of time, (i) heating said gelatinous elastomer pieces, and (j) forming said gelatinous elastomer pieces into a desired article. The method entails the further steps of compounding a plasticizer with an SEEPS triblock copolymer to form a gelatinous elastomer, and forming said gelatinous elastomer pieces into a desired article; or compounding a plasticizer with an SEEPS A-B-A triblock copolymer to form molten gelatinous elastomer, forcing molten gelatinous elastomer through an extrusion die, and receiving a formed gelatinous elastomer article from said extrusion die. An alternative method comprised the steps of (a) selecting a plasticizer that includes a plurality of plasticizing polymer molecules, (b) selecting an elastomer comprising a plurality of elastomeric triblock copolymers of the general configuration A-B-A, each of said triblock copolymers having: two end blocks A and one mid block B, and a plurality of hollow spherical objects; wherein each of said mid block B is covalently linked to one of said end blocks A; wherein said end blocks A are non-elastomeric polymers; wherein said mid block B is an elastomeric polymer, wherein said mid block B of at least some of said triblock copolymers includes a plurality of backbone carbon molecules and a plurality of side chains; wherein said elastomer has a weight average molecular weight of at least about 300,000 when determined by gel permeation chromatography; wherein said plasticizing polymer molecules, upon placement of the material under a load, tend to facilitate disentanglement and elongation of said mid blocks B during elongation of the material; wherein said plasticizing polymer molecules, upon release of the load from the material, tend to facilitate recontraction of the material; wherein said plasticizing polymer molecules comprise at least about 60 weight percent of the material, based on the combined weights of said triblock copolymers and said plasticizing polymers; wherein said elastomer has a measurable percent elongation at break; wherein said plasticizer tends to increase the percent elongation at break of said elastomer; wherein said elastomer has a rigidity measurable on the Gram Bloom scale, and wherein said plasticizer tends to decrease the Gram Bloom rigidity of said elastomer; (c) mixing said plasticizer and said triblock copolymer by a method selected from the group consisting of melt blending and use of a compounding screw in order to produce a gelatinous elastomer, (d) permitting said gelatinous elastomer to cool, (e) selecting a forming device, (f) melting said gelatinous elastomer, and (g) using said forming device in order to form said gelatinous elastomer into a desired shape. Alternatively, the heated and mixed homogenous (melt blended, augured, and/or compounding screwed) gelatinous elastomeric material can be immediately poured into a mold without being cooled and re-melted. Forming the gelatinous elastomer material into a desired shape is normally accomplished by pouring the re-melted or originally melted gelatinous elastomer material into a mold or equivalent thereof.

Variations of that process also include mixing the polymers and plasticizer with already formed gelatinous elastomeric material in order to decrease potential waste material.

### Gel Configurations

A desired shape is a columned gelatinous elastomeric cushion or alternatively referred to as a honey-comb cushion. Documents which disclose gelatinous elastomeric cushions include: U.S. Pat. No. 5,456,072 issued in the name of Stern on Oct. 10, 1995; U.S. Pat. No. 5,362,834 issued in the name of Schapel et al. on Nov. 8, 1994; U.S. Pat. No. 5,334,646 issued in the name of Chen on Aug. 2, 1994; U.S. Pat. No. 5,191,752 issued in the name of Murphy on Mar. 9, 1993; and U.S. Pat. No. 4,913,755 issued in the name of Grim on Apr. 3, 1990, each of which is hereby incorporated by reference in its entirety. Those gelatinous cushion materials were not directed to honey-combed cushions.

Examples of honeycomb or multilayer film cushions are as follows: U.S. Pat. No. 5,445,861 issued in the name of Newton et al. on Aug. 29, 1995; U.S. Pat. No. 5,444,881 issued in the name of Landi et al. on Aug. 29, 1995; U.S. Pat. No. 5,289,878 issued in the name of Landi on Mar. 1, 1994; U.S. Pat. No. 5,203,607 issued in the name of Landi on Apr. 20, 1993; U.S. Pat. No. 5,180,619 issued in the name of Landi et al. on Jan. 19, 1993; U.S. Pat. No. 5,015,313 issued in the name of Drew et al. on May 14, 1991; U.S. Pat. No. 5,010,608 issued in the name of Barnett et al. on Apr. 30, 1991; U.S. Pat. No. 4,959,059 issued in the name of Eilender et al. on Sep. 25, 1990; U.S. Pat. No. 4,485,568 issued in the name of Landi et al. on Dec. 4, 1984; U.S. Pat. No. 5,749,111 to Pearce on May 12, 1998; and U.S. Pat. No. 7,730,566 to Flick on Jun. 8, 2010; U.S. Pat. No. 7,076,822 to Pearce on Jun. 18, 2006, each of which is hereby incorporated by reference in its entirety.

In U.S. Pat. No. 7,076,822; Pearce wrote about a generic version of a columned gelatinous elastomeric cushion. In particular, Pearce wrote, “the cushioning element . . . includes gel cushioning media formed generally into a rectangle with four sides, a top and a bottom, with the top and bottom being oriented toward the top and bottom of the page, respectively. The cushioning element has within its structure a plurality of hollow columns . . . . As depicted, the hollow columns . . . contain only air. The hollow columns . . . are open to the atmosphere and therefore readily permit air circulation through them, through the cover . . . fabric, and to the cushioned object. The columns . . . have column walls . . . which in the embodiment depicted are hexagonal in configuration. The total volume of the cushioning element may be occupied by not more than about 50% gel cushioning media, and that the rest of the volume of the cushioning element will be gas or air. The total volume of the cushioning element may be occupied by as little as about 9% cushioning media, and the rest of the volume of the cushion will be gas or air. This yields a lightweight cushion with a low overall rate of thermal transfer and a [low] overall thermal mass. It is not necessary that this percentage be complied with in every instance.” The hollow columns can have any of the following shapes: triangular, rectangular, square, pentagonal, hexagonal, heptagonal, octagonal, round oval, and any n-sided polygonic shape. The periphery of the cushioning element may also be triangular, rectangular, square, pentagonal, hexagonal, heptagonal, octagonal, round oval, heart shaped, kidney-shaped, elliptical, oval, egg-shaped, n-sided polygonic shape or any other shape. This embodiment is referred to as a “single height gel configuration.”

When a patient is positioned on the gelastic material, the patient's protuberances (the hip(s), shoulder(s), arm(s), buttock(s), shoulder blade(s), knee(s), and/or heel(s)) cause the column walls positioned below the patient's protuberances to bend and/or compress. Those bent/compressed column walls are not supposed to collapse or fail because then the patient would bottom out on the underlying surface. Instead, the column walls positioned below and receiving the weight of the patient's protuberances bend and/or compress to redistribute and/or lessen the load of those column walls to other column walls of the gelastic material. In other words, compressing and/or bending the column (or side) walls permit the cushioning element to conform to the shape of the cushioned object while (a) evenly distributing a supporting force across the contact area of the cushioned object, (b) avoiding pressure peaks against the user, and (c) decreasing the chance of the patient bottoming out. This embodiment is also referred to as a “single height gel configuration.”

Pearce disclosed numerous cushion embodiments to solve potential bottoming out problems. One cushion embodiment depicts a cross section of a cushioning element using alternating stepped columns. The cushioning element has a plurality of columns each having a longitudinal axis, a column top and a column bottom. The column top and column bottom are open, and the column interior or column passage is unrestricted to permit air flow through the column. The column depicted has side walls, each of which has three distinct steps. The columns are arranged so that the internal taper of a column due to the step on its walls is opposite to the taper of the next adjacent column. This type of cushioning element could be made using a mold. This embodiment is also referred to as a “single height gel configuration.”

A problem with Pearce's stepped column embodiment is that the side walls do not uniformly compress/bend due to the varied thicknesses. As previously stated, compress/bend the column (or side) walls permit the cushioning element to conform to the shape of the cushioned object while evenly distributing a supporting force across the contact area of the cushioned object and avoiding pressure peaks against the user. Compressing/bending is difficult when the side walls are thick and tapered as disclosed in Pearce's stepped column gelastic material embodiment. The thicker portion of the walls do not decrease pressure peaks, instead the thicker portion of the walls maintain or increase the pressure peaks. Those pressure peaks are to be avoided and are not in Pearce's stepped column gelastic material embodiment.

Pearce also discloses a gelastic cushion having a firmness protrusion device positioned within the column walls to prevent the column walls from failing or collapsing so the patient bottoms out. In particular, Pearce wrote that the cushioning element has cushioning medium formed into column walls. The column walls form a column interior. The column has an open column top and a closed column bottom. In the embodiment depicted, the column has a firmness protrusion protruding into the column interior from the column bottom. The firmness protrusion depicted is wedge or cone shaped, but a firmness protrusion could be of an desired shape, such as cylindrical, square, or otherwise in cross section along its longitudinal axis. The purpose of the firmness protrusion is to provide additional support within a buckled column for the portion of a cushioned object that is causing the buckling. When a column of this embodiment buckles, the cushioning element will readily yield until the cushioned object begins to compress the firmness protrusion. At that point, further movement of the cushioned object into the cushion is slowed, as the cushioning medium of the firmness support needs to be compressed or the firmness support itself needs to be caused to buckle in order to achieve further movement of the cushioned object into the cushioning medium. The firmness protrusion is a block of material designed to inhibit further buckling of the column walls. At best due to its shape and function, the firmness protrusion does not buckle. This embodiment is also referred to as a “single height gel configuration.”

Another cushion embodiment is a stacked gelastic cushion embodiment which was claimed in U.S. Pat. No. 7,076,822. The stacked cushion embodiment as claimed has the following limitations: “(a) a first cushioning element and a second cushioning element stacked together in sequence to form a stacked cushion, (b) said stacked cushion having a stacked cushion bottom; (c) said first cushioning element including (i) a quantity of first gel cushioning medium formed to have a first cushioning element top, a first cushioning element bottom, and a first outer periphery, said first gel cushioning medium being compressible so that it will deform under the compressive force of a cushioned object; (ii) wherein said first gel cushioning media is flexible and resilient, having shape memory and being substantially solid and non-flowable at temperatures below 130° Fahrenheit; (iii) a plurality of first hollow columns formed in said first gel cushioning medium, each of said first hollow columns having a first longitudinal axis along its length, each of said first hollow columns having a first column wall which defines a first hollow column interior, and each of said first hollow columns having two ends; (iv) wherein each of said first column ends is positioned at two different points of said first longitudinal axis; (v) wherein at least one of said first hollow columns of said first cushioning element is positioned within said first gel cushioning medium such that said first longitudinal axis is positioned generally parallel to the direction of a compressive force exerted on the stacked cushion by a cushioned object in contact with the stacked cushion; [sic] (c) wherein the stacked cushion is adapted to have a cushioned object placed in contact with said stacked cushion top; and [sic] (d) wherein at least one of said first column walls of said first cushioning element is capable of buckling beneath a protuberance that is located on the cushioned object.” The stacked gelastic cushion embodiment is unstable unless the first cushioning element and the second cushioning element are secured to each other. Securing the two cushions together can be accomplished by adhesives and/or straps (rubber, cloth or equivalent) without fasteners (like a rubber band) or with fasteners (i.e., hook and loop, buckles and/or tying).

In U.S. Pat. No. 7,730,566, which is hereby incorporated by reference and commonly assigned, Flick discloses multi-walled gelatinous elastomeric cushion. The gelastic cushion has a structure having a first wall that defines an opening area. The opening area can be triangular, rectangular, square, pentagonal, hexagonal, heptagonal, octagonal, round oval, any n-sided polygonic shape or any other shape. The periphery of the cushioning element may also be triangular, rectangular, square, pentagonal, hexagonal, heptagonal, octagonal, round oval, heart shaped, kidney-shaped, elliptical, oval, egg-shaped, any n-sided polygonic shape or any other shape. The first wall compresses/bends when a force is applied to the first wall. Within the first wall's opening area, there is a second wall interconnected to the first wall and at a lower height than the first wall. When the first wall compresses/bends a predetermined amount, the second wall, interconnected to the first wall, also compresses/bends. The second wall decreases the chance that the first wall bottoms out. Bottoming out increases the pressure on the patient (a.k.a., the force) overlying the gelastic cushion. This configuration is known as a “multi-height gelatinous elastomeric hollow columned configuration.”

Those gel configurations are normally uniform throughout the gelatinous elastomeric material, especially when the material is being utilized as a mattress or a pad. In some instances, the mattress or pad is positioned over a gatching bed frame. A gatching bed frame is commonly referred to as a hospital bed wherein there are two or more sections. A first section moves a patient's torso up and down to desired positions; a second section moves a patient's (a) hips, thigh, and buttocks up and down to desired positions or (b) hips, buttocks, calfs, feet, and thighs up and down to desired positions; and optionally a third section moves a patient's calfs and feet up and down to desired positions. Applicant has noticed that when the gelatinous elastomeric material is shaped like a mattress and positioned over a gatching mattress, the mattress actually increases in shear at or near the junction between the gatching bed frame's respective sections. Increased shear is undesirable because it can increase the chance that debuticus ulcers will form.

The present invention solves that problem for the above-identified gelatinous elastomeric compositions, gelatinous elastomeric manufacturing processes, and gelatinous elastomeric configurations.

### SUMMARY OF THE INVENTION

A gelatinous elastomeric cushion having decreased shear forces applied to the patient by altering the gelatinous elastomeric configuration in certain areas. For example, the decreased gelatinous elastomeric material does not have secondary walls align with each other. Alternatively, the cushion has different gelatinous configurations in different sections of the cushion to intentionally elongate the walls to decrease the shear pressure applied to the patient.

### BRIEF DESCRIPTION OF THE DRAWINGS

Various cross-hatching lines are used in the figures to identify different structural components. Those structural components having different cross-hatching in the figures can be the same material or different materials.

FIG. 1 illustrates an isometric view of the present invention.

FIG. 2 is a top view of FIG. 1 taken only at box 2.

FIG. 3 is a cross-sectional view of FIG. 2 taken along the lines 3-3.

FIG. 4 illustrates a first embodiment of a top view of FIG. 2 when an object buckles just the first wall.

FIG. 5 is a cross-sectional view of FIG. 4 taken along the lines 5-5.

FIG. 6 illustrates a second embodiment of a top view of FIG. 2 when an object buckles the first wall and the second wall, not the third wall.

FIG. 7 is a cross-sectional view of FIG. 6 taken along the lines 7-7.

FIG. 8 is top view of mold components to form one embodiment of the present invention.

FIG. 9 is front view of FIG. 8 taken along the lines 9-9 that illustrates component 102a and a portion of component 102d.

FIG. 10 illustrates an alternative embodiment of FIG. 3.

FIG. 11 illustrates FIG. 10 taken along the lines 11-11.

FIG. 12 illustrates an alternative embodiment of FIG. 3.

FIG. 13 illustrates FIG. 12 taken along the lines 13-13.

FIG. 14 illustrates an alternative embodiment of FIG. 3.

FIG. 15 illustrates FIG. 14 taken along the lines 15-15.

FIG. 16 illustrates an alternative embodiment of FIG. 3.

FIG. 17 illustrates FIG. 16 taken along the lines 17-17.

FIGS. 18a and b illustrate alternative embodiments of FIG. 3 with a bottom (skin) layer, an aperture, and an interconnector.

FIG. 19 illustrates an alternative embodiment of FIG. 8 with an extra mold positioned on a mold component or an indentation in the mold component.

FIG. 20 illustrates a front view of FIG. 19 taken from arrow 20.

FIG. 21 illustrates an alternative embodiment of FIG. 2.

FIG. 22 illustrates a mattress configuration that uses the present invention.

FIG. 23 illustrates an alternative embodiment of FIG. 3 wherein the cushion is used upside down.

FIG. 24 is a cross-sectional view of FIG. 19 taken along the lines 31-31.

FIG. 25 is an alternative embodiment of FIG. 3.

FIG. 26 is an alternative embodiment of FIG. 3.

FIG. 27 is a gatching gelatinous elastomeric cushion system.

FIG. 28 is an alternative gel configuration.

FIGS. 29-34 are illustrations of prior art gatch bed frames.

### DETAILED DESCRIPTION OF THE PRESENT INVENTION

Definition: The term “buckle” means the column walls bend and do not collapse (a.k.a., complete failure) when a patient is positioned thereon unless the patient is extremely heavy (for example but not limited to over 350 pounds).

The present invention as illustrated at FIG. 27 is directed to a gelatinous elastomeric cushion material 1000 having a decreased shear gatching area 1200.

The gelatinous elastomeric cushion material 1000 has a first gelatinous cushion area 2000 and a second gelatinous cushion area 2200 interconnected by the decreased shear gatching area 1200. The first gelatinous cushion area 2000 is designed to be positioned over a gatch bed frame's head section, seat/thigh section and/or foot section; the second gelatinous cushion area 2200 is designed to, be positioned over an adjacent section of the gatch bed frame's head section, seat/thigh section and/or foot section in relation to the first gelatinous cushion area 2000; while the decreased shear gatching area 1200 is designed to be positioned over the pivot area between the first gelatinous cushion area 2000 and the second gelatinous cushion area 2200.

The first gelatinous cushion area 2000 is a single height gel configuration (as defined above and illustrated in FIG. 27), a multi-height gelatinous elastomeric hollow columned configuration (as described above and below), a decreased pressure point multi-height gelatinous elastomeric hollowed columned configuration (as described below), an alternative decreased pressure point multi-height gelatinous elastomeric configuration (as described below) and combinations thereof. Likewise, the second conventional gelatinous elastomeric cushion area 2200 is the single height gel configuration, the multi-height gelatinous elastomeric hollow columned configuration, a decreased pressure point multi-height gelatinous elastomeric hollowed columned configuration (as illustrated in FIG. 27), an alternative decreased pressure point multi-height gelatinous elastomeric configuration (as described below) and combinations thereof.

The multi-height gelatinous elastomeric hollow columned configuration described above (which is commonly assigned to the current assignee) describe a primary wall or walls 5000 that define a hollow column 5200; within the hollow column 5200, there is a secondary wall 5400 that has a height less than the primary wall(s), contacts the primary wall(s), and extends across the hollow column. In the embodiments illustrated in U.S. Pat. No. 7,730,566; the secondary wall in each hollow column was uniformly positioned so each secondary wall appeared as though it was a continuous line extending from one hollow column to another adjacent hollow column.

Applicant determined that to decrease the shear force applied to the patient it is preferable the second wall not appear to be a continuous line extending from one hollow column to another adjacent hollow column as illustrated in the prior art. Instead, applicant has determined that it is preferred that a first second wall 4400a in a first hollow column 4200a extends in a first direction; while a second wall 4400b (a) in an adjacent second hollow column 4200b extends in a second direction distinct from the first direction, for example and not limited to being orthogonal to each other, (b) in an adjacent third hollow column 4200c is parallel to the first direction, and/or (c) does not exist in an adjacent fourth hollow column 4200d. This gel configuration decreases the number of pressure points, a location in which three or more gelatinous walls intersect, in the gelatinous cushion material. By decreasing the number of pressure points, applicant confirmed the gelatinous elastomeric material's force applied to the patient decreases. This embodiment is referred to as a “decreased pressure point multi-height gelatinous elastomeric configuration”

This decreased pressure point multi-height gelatinous elastomeric configuration also decreases the amount of gelatinous material used in the cushion material to inhibit bottoming out. It is preferred the multi-height gelatinous elastomeric hollow columned configuration and/or the decreased pressure point multi-height gelatinous elastomeric hollowed columned configuration is positioned, at least, over the gatch bed's seat/thigh section to decrease a patient bottoming out to the underlying support frame.

The hollow columns in the first gelatinous cushion area 2000 and the second gelatinous cushion area 2200 that use the standard gelatinous elastomeric hollow columned configuration, the multi-height gelatinous elastomeric hollow columned configuration and/or the decreased pressure point multi-height gelatinous elastomeric hollowed columned configuration can be, and are preferably the same shape. A preferred hollow columned shape is diamond shape. The diamond shape, in relation to a square shape or any other shape, has been determined to apply a decreased shear force to an overlying patient which decreases the chance of the formation of debuticus ulcers. The diamond shape allows the primary walls to increase its respective elongation toward the sides. That increased elongation decreases the cushion's forces applied to the patient which in turn decreases the chance of the formation of debuticus ulcers on the patient. The increased elongation occurs, but not as efficiently as the diamond shape, when the hollow columns are in a square shape and positioned in a gatch position (for example the patient's torso is positioned above the patient's buttocks; or alternatively vice versa).

Applicant has also discovered that the decreased shear gatching area 1200 must have a different configuration than the first gelatinous cushion area 2000 and the second gelatinous cushion area 2200. The decreased shear gatching area 1200 contains a gelatinous elastomeric material and at least one wall. The at least one wall has a top surface 3400, a bottom surface (not shown) wherein the top surface and the bottom surface each have a predetermined width and are separated a predetermined distance by the wall's vertical surface having two side surfaces—a first surface and a second surface. The two side surfaces 2150a,b, excluding tangential lines from the two side surfaces 2150 when the surfaces are circular shape, do not align with the first gelatinous cushion area's and the second gelatinous cushion area's wall's side surface to form a straight line. Instead, the two side surfaces 2150 are at angles offset from the direction of the first gelatinous cushion area's and the second gelatinous cushion area's wall's side surfaces as illustrated in FIG. 27.

The different configuration in the decreased shear gatching area 1200 allows the walls in the respective first gelatinous cushion area 2000 and second gelatinous cushion area 2200 to have increased elongation when the cushion 1000 is in the gatch position (one section is higher than the other) and/or being gatched ((a) horizontal position to (b) a seated position or a legs-down position; and vice versa). An example of the different decreased shear gatching area configuration, as illustrated at FIG. 27 and not limited to such design, is a multiple, adjacent step pyramid configuration. The multiple, adjacent step pyramid configuration, and other shapes including the decreased pressure point multi-height gelatinous elastomeric configuration described above, the alternative decreased pressure point multi-height gelatinous elastomeric configuration described below, has a different configuration that decreases the shear force of the cushion 1000 applied to a patient lying thereon. That altered configuration allows the respective first gelatinous cushion area 2000 and second gelatinous cushion area 2200 to elongate further than if the decreased shear gatching area 1200 had the same configuration as the first gelatinous cushion area 2000 and/or second gelatinous cushion area 2200. The further elongation of the first gelatinous cushion area 2000 and second gelatinous cushion area 2200 occurs, or is experienced, when the cushion 1000 is being gatched, or gatched. That increased elongation provides shear relief to the patient.

The alternative decreased pressure point multi-height gelatinous elastomeric configuration 1100 is illustrated at FIG. 28. FIG. 28 illustrates a decreased pressure point multi-height gelatinous elastomeric configuration having a plurality of wheel shaped gelatinous elastomeric materials 1102. As illustrated, each wheel shaped gelatinous elastomeric material 1102 interconnects to an interconnection gelatinous elastomeric cylinder 1104 through interconnection gelatinous elastomeric spokes 1106.

Each wheel shaped gelatinous elastomeric material 1102 has a circular hub gelatinous elastomeric wall 1122 defining a circular hollow hub area 1124 within its interior surface 1126. Extending from the circular hub gelatinous elastomeric wall's exterior surface 1138 is a plurality of first spoke gelatinous elastomeric walls 1130. The first spoke gelatinous elastomeric walls 1130 interconnect the circular hub gelatinous elastomeric wall 1122 to a first rim gelatinous elastomeric wall 1140. The first rim gelatinous elastomeric wall 1140 forms, excluding the first spoke gelatinous elastomeric walls 1130, a first hollow area 1145 between the first rim gelatinous elastomeric wall's interior surface 1142 and the circular hub gelatinous elastomeric wall's exterior surface 1138. Extending from the first rim gelatinous elastomeric wall's exterior surface 1144 is a plurality of second spoke gelatinous elastomeric walls 1146. The second spoke gelatinous elastomeric walls 1146 interconnect first rim gelatinous elastomeric wall's exterior surface 1144 to a second rim gelatinous elastomeric wall 1150. The second rim gelatinous elastomeric wall 1150 forms, excluding the second spoke gelatinous elastomeric walls 1146, a second hollow area 1155 between the first rim gelatinous elastomeric wall's exterior surface 1144 and the second rim gelatinous elastomeric wall's interior surface 1152. Likewise, the interconnection gelatinous elastomeric spokes 1106 interconnect the second rim gelatinous elastomeric wall's exterior surface 1154 and the interconnection gelatinous elastomeric cylinder 1104.

In addition, the second spoke gelatinous walls 1146 and the first spoke gelatinous elastomeric walls 1130 are offset from each other so neither spoke walls 1146, 1130 are in the same plane or appear to be in the same plane to avoid pressure points. Likewise, the second spoke gelatinous walls 1146 and the interconnection gelatinous elastomeric spokes 1106 are offset from each other so neither spoke walls 1146, 1106 are in the same plane or appear to be in the same plane to avoid pressure points.

As illustrated, the second rim gelatinous elastomeric wall's exterior surface 1154 of a first wheel shaped gelatinous elastomeric material 1102a can contact a second wheel shaped gelatinous elastomeric material's (1102b) second rim gelatinous elastomeric wall's exterior surface 1154. It is also preferred that the second rim gelatinous elastomeric wall 1150 of the first wheel shaped gelatinous elastomeric material 1102 and the second wheel shaped gelatinous elastomeric material 1102 are not in the same plane nor appear to be in the same plane to avoid pressure points.

The first gelatinous cushion area 2000 and the second gelatinous cushion area 2200 can be identical or different (as illustrated in FIG. 27). In the embodiment illustrated in FIG. 27, the first conventional gelatinous cushion area's top surface 3000, the decreased shear gatching area's top surface 3400 and the second conventional gelatinous cushion area's top surface 3200 are in the same plane when the gelatinous cushion 1000 is in a supine (a.k.a., flat) position.

The top surface of the gelatinous cushion material 1000 when positioned on a gatch bed frame in a horizontal position can be in the same plane.

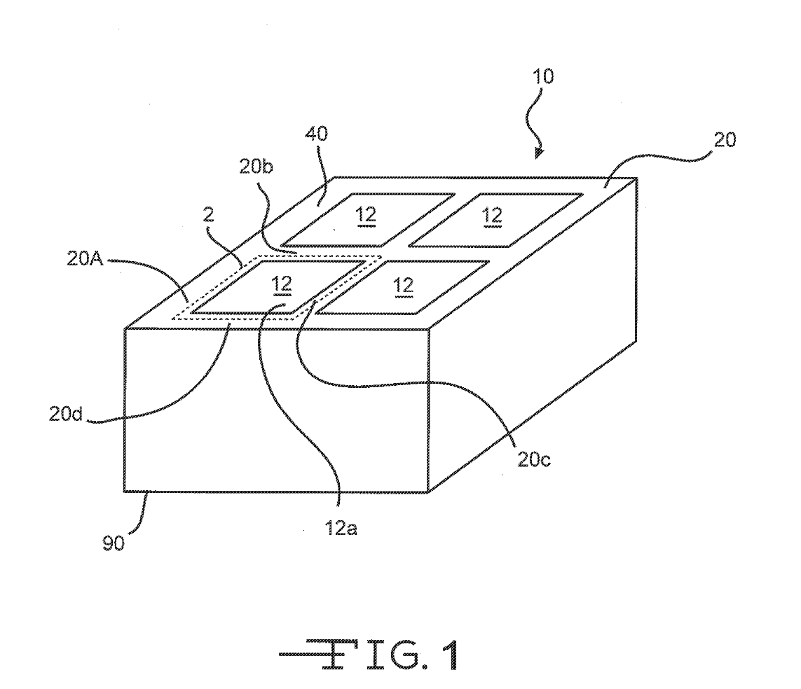

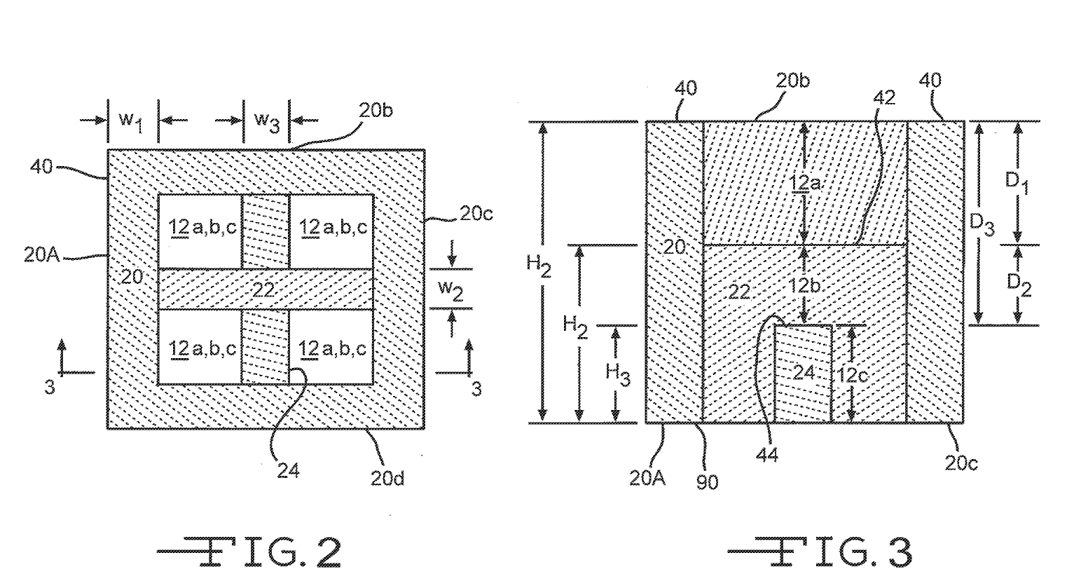

FIG. 1 illustrates a close-up view of either the first gelatinous cushion area 2000 and/or the second gelatinous cushion area 2200 of the gelatinous cushion section 10 having a first wall 20 defining opening areas 12 positioned throughout the gelastic cushion 1000. To understand and appreciate a portion of the present invention, we must look at (1) FIG. 2 which is an overview of FIG. 1 at the area identified as box 2 (for illustration purposes only the first wall 20 in box 2 has been defined as first walls 20a-d and a portion of the opening area 12 in box 2 is defined as opening area 12a) and (2) FIG. 3 which is a cross-sectional view of FIG. 2 taken along the lines 3-3.

FIGS. 2 and 3 illustrate three walls 20, 22, 24. The first wall 20 is the tallest wall and it defines the first opening area 12a (see FIG. 1) and has a height H1 (see FIG. 3). The first wall 20 has a width W1 that allows it to buckle into the first opening 12a, a second opening 12b (defined below), a third opening 12c (defined below) or alternatively in (a) a corresponding opening 12 (see FIG. 1) and/or (b) exterior to the perimeter of the gelastic cushion 10. The first wall 20 has a top surface 40 that receives a patient thereon.

The second wall 22 (a) is an intermediate wall height that has a height H2 and (b) defines with the first wall 20 at least two second openings 12b. The difference between H1 and H2 is distance D1. The second wall 22 has a width W2 that allows it to buckle into the second opening 12b or the third opening 12c if a patient's weight (and/or a force is applied to the gelastic material) is sufficient to buckle the first wall 20a distance D1+. D1+ is any distance greater than D1 and W1 and W2 can be the same width or different widths.

The third wall 24 (a) is a lower wall height and has a height H3 and (b) defines with the first wall 20 and the second wall 22 at least four third openings 12c. The difference between H1 and H3 is distance D3 and the difference between H2 and H3 is distance D2. The third wall has a width W3 that allows it to buckle if a patient's weight (and/or a force is applied to the gelastic material) is sufficient to buckle (a) the first wall 20a distance D3+ and (b) the second wall 22 a distance D2+. D2+ is any distance greater than D2 and D3+ is any distance greater than D3. W1, W2 and W3 can be the same width, different widths or combinations thereof.

### Operation of the Gelastic Cushion

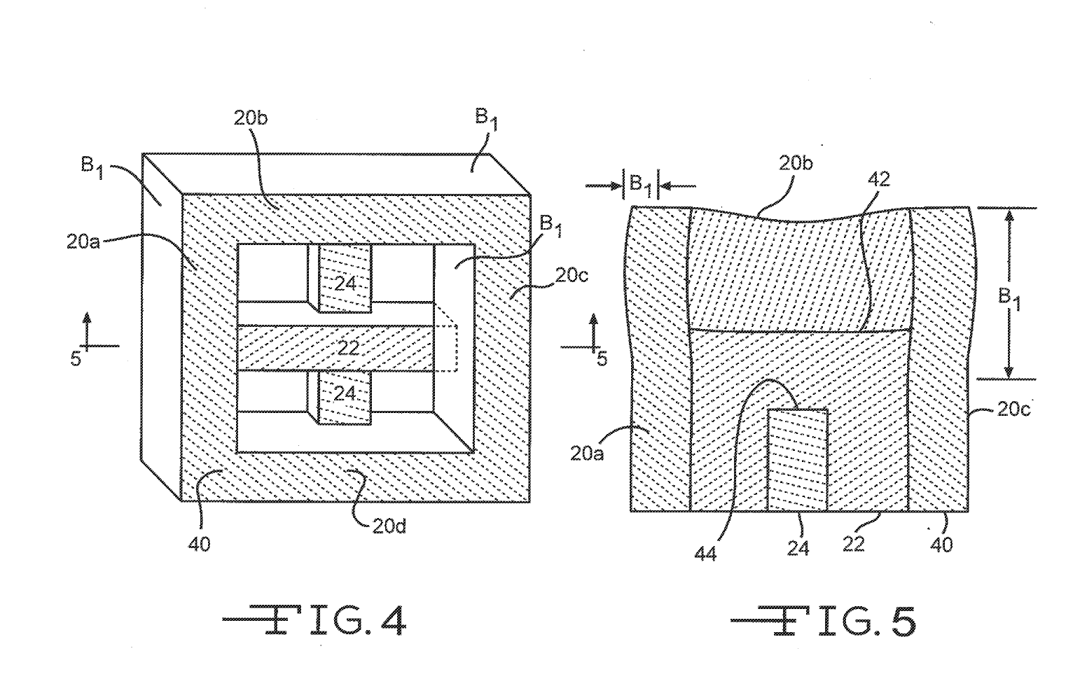

Turning to FIGS. 4 and 5, if an object (not shown) is positioned on the gelastic material 10 and the object's weight causes the first wall 20 (each portion of the first wall is identified individually as 20a, 20b, 20c and in other FIG. 20d) to buckle (B1) a distance D1−. D1− is a distance less than D1, or a distance D1. When the first wall 20 only buckles a distance D1− the second wall 22 and the third wall 24 do not buckle, as illustrated in FIGS. 4 and 5. Instead the second wall 22 and the third wall 24 can be stretched (redistribution or lessening of the load) to accommodate the buckling (B1) of the first wall 20.

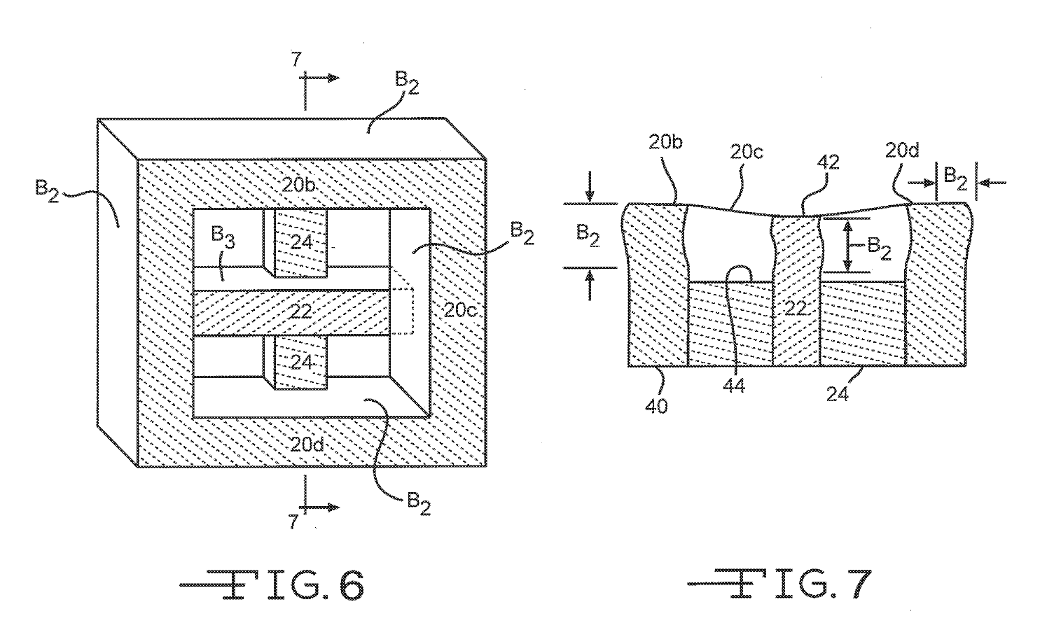

FIGS. 6 and 7 illustrate when an object (not shown) is positioned on the gelastic material 10 and the object's weight causes the first wall 20 to buckle (B2) a distance D1+ which then means that the second wall 22 buckles (B3). In FIGS. 6 and 7 the second wall 22 buckles (B3) a distance D2− and the first wall buckles (B2) a distance D3− so that the third wall 24 does not buckle but can be stretched to accommodate the buckling of the first wall 20 and the second wall 22. D3− is a distance less than D3 and D2− is a distance less than D2. When the second wall 22 buckles, the second wall 22 provides increased support to the object to distribute the patient's weight when the first wall 20 buckles a predetermined distance D1+.

When the second wall 22 buckles, the present invention provides a similar support as the stacked cushion embodiment that was disclosed in the prior art. The similarities between the present invention and the stacked cushion embodiment differ in that there is no material used to interconnect two different cushions. That interconnection could (a) increase pressure on the patient or (b) be defective so the stacked cushions separate from each other. The present invention avoids those potential problems by having multiple height buckling walls within and surrounding each opening area 12.

The multiple heights buckling walls within and surrounding each opening area 12 differs from the multi-tiered embodiment disclosed in the prior art. The multi-tiered embodiment does not have each tier buckle uniformly because the thicker sections do not buckle as well as the thinner section. The present invention has each wall of the multiple heights buckling wall buckle essentially uniformly when the appropriate force is applied to it which provides the desired distribution of weight and decreased pressure on the patient.

As indicated above, the third wall 24 buckles when the first wall 20 buckles a distance D3+ and the second wall 22 buckles a distance D2+. Even though not shown, when the third wall 24 buckles the third wall 24 provides further support to (1) decrease any pressure on the patient and (2) distribute the patient's weight when the first wall 20 buckles a predetermined distance D3+ and the second wall 22 buckles a distance D2+.

### How Made

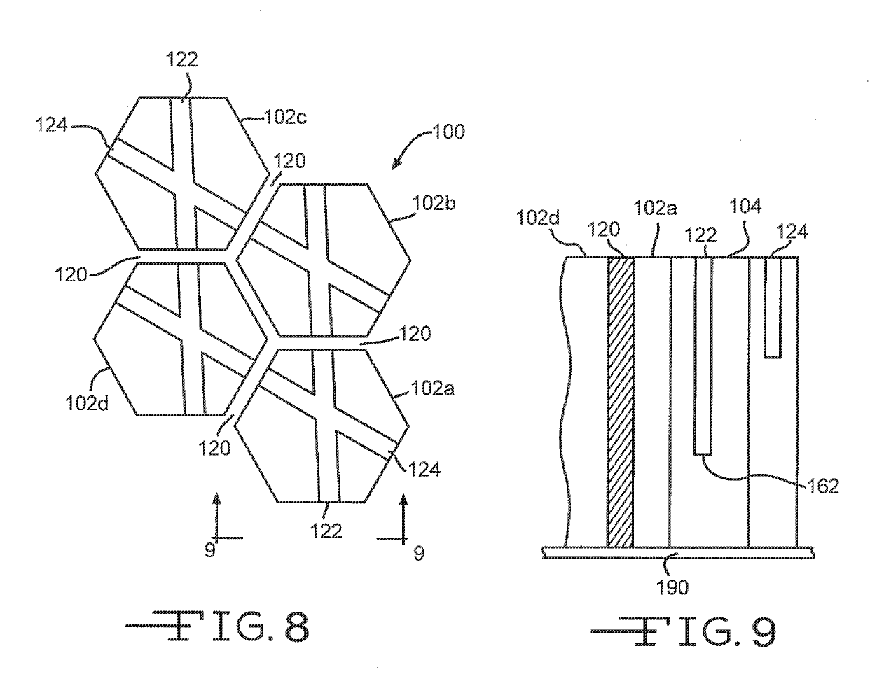

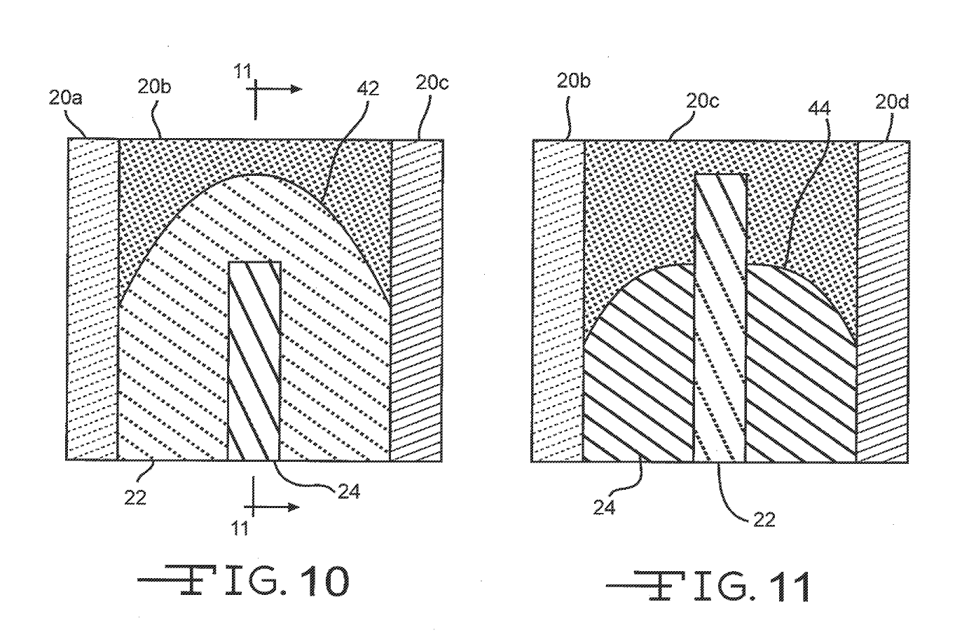

The example illustrated in FIG. 1 shows first walls in a rectangular shape which includes a square and a diamond shape (a rotated square). The first walls can be any shape including circles, pentagons, hexagons (as alluded to in FIGS. 8 and 9), n-sided polygonic shape, or any other desired shape that will allow the first wall and the second wall (and possible other walls) to buckle as desired.

FIGS. 8 and 9 illustrate four components 102a,b,c,d of a mold 100 that form an embodiment of the gelastic cushion 10 having multiple heights buckling walls within and surrounding an opening area. The mold 100 is a conventional mold having components that can withstand the gelastic material in a molten state. That material can be metal, polymeric and/or combinations thereof.

The mold 100 as illustrated in FIG. 8 shows four components 102a,b,c,d, in a hexagonal shape. The gelastic material is poured onto the mold 100 and the gelastic material that falls within (a) the gaps 120 form the first walls 20, (b) the gaps 122 form the second walls 22 and (c) the gaps 124 form the third walls 24. FIG. 8 illustrates the top of the mold 100, which illustrates the gelastic cushion's bottom surface 90.

FIG. 9 illustrates component 102a and a portion of component 102d from arrow 9 in FIG. 8. As alluded by FIGS. 2 to 9, the first wall 20 is defined by (a) the gap 120 positioned between the various components 102 a,b,c,d and (b) a bottom surface 190 of the mold 100 (the top 90 of the gelastic material 10). In contrast the second wall 22 is defined entirely by the gap 122 in each component 102, and the third wall 24 is defined entirely by the gap 124 in each component 102.

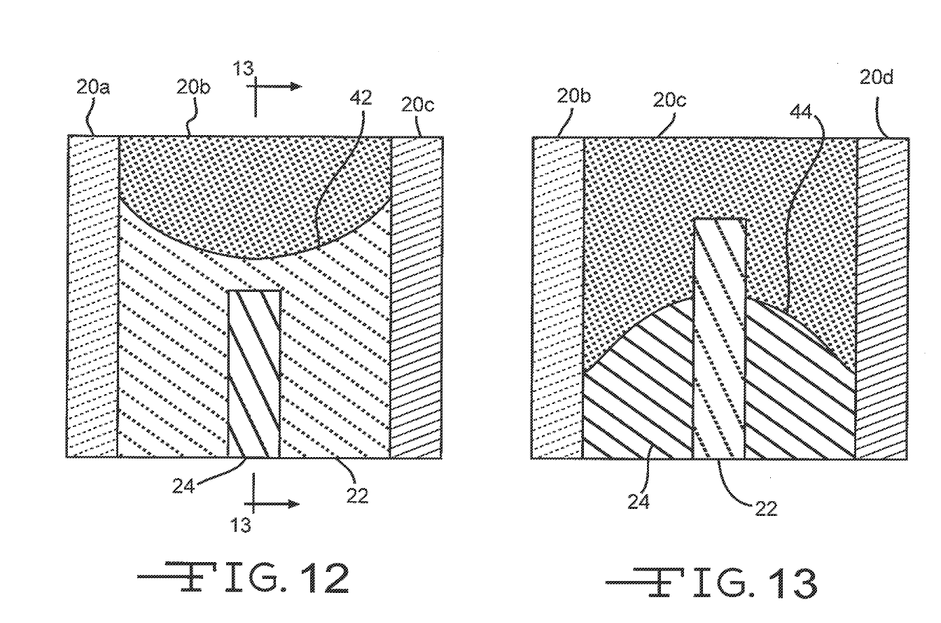

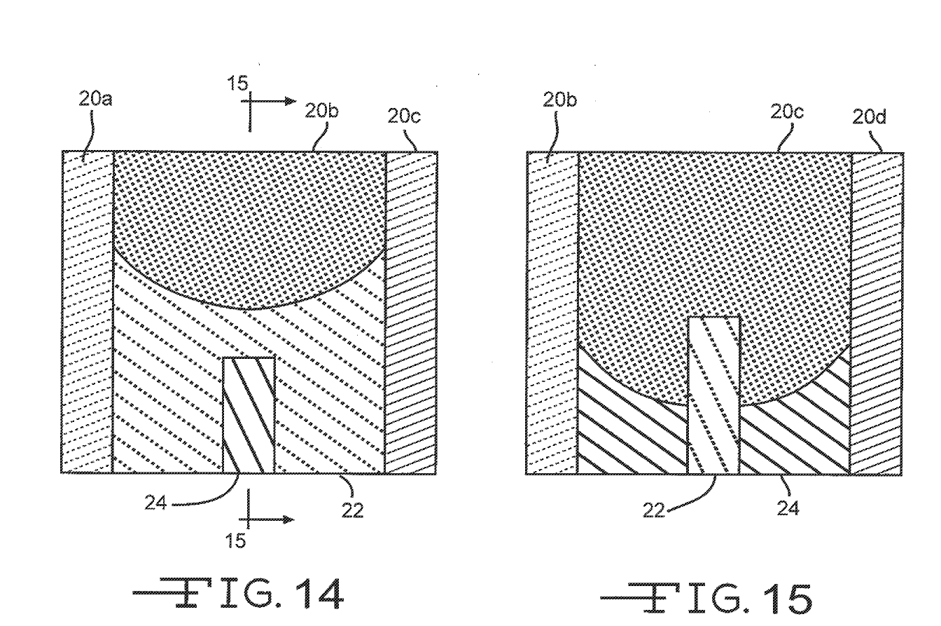

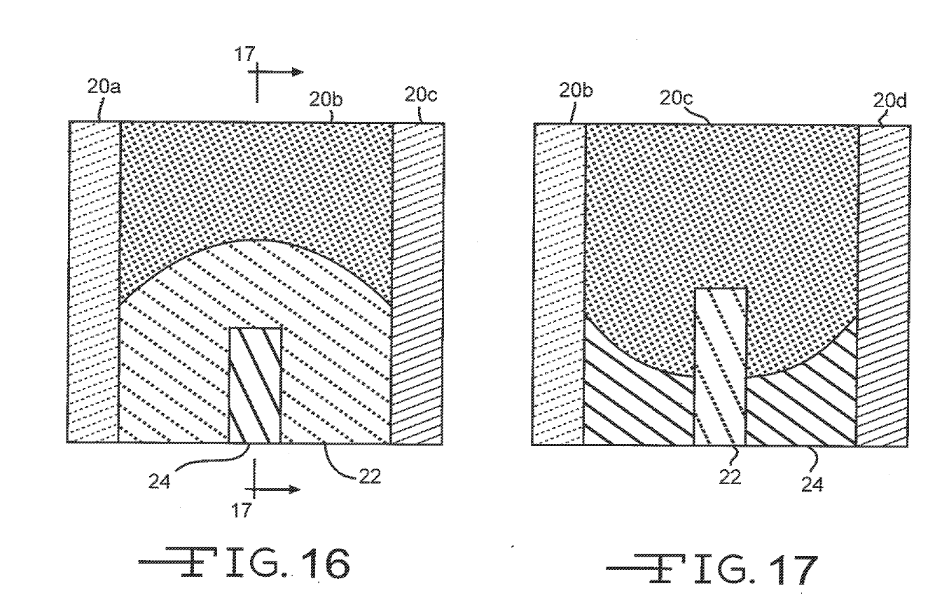

As illustrated in FIGS. 3, 5, and 7, the second wall 22 has a top surface 42 that is level and the third wall 24 has a top surface 44 that is level. Those top surfaces 42, 44 can also be concave, convex, level or combinations thereof. Examples, and not limitations, of those embodiments are illustrated in FIGS. 10 to 17. Those alternative embodiments for the top surfaces 42, 44 can be defined by altering the shape in the gaps 122, 124 in each component. It is well known that concave, convex and level top surfaces can strengthen, weaken or maintain the present support of the first wall 20, the second wall 22 and/or the third wall 24. By having various shaped top surfaces 42, 44 in different portions of the gelastic cushion, the gelastic cushion 10 can have various levels of support provided by the various walls 20, 22, 24 throughout the gelastic cushion 10.

### Bottom Layer

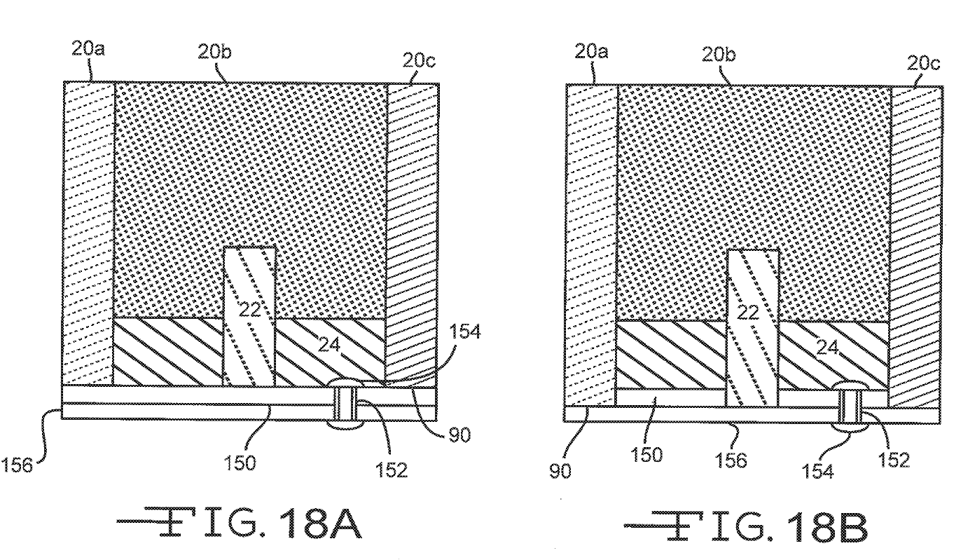

The bottom 90 of the gelastic material 10 can have a bottom layer (a.k.a., skin layer) 150 as illustrated in FIG. 18a that extends beyond the bottom of the rest of the gelastic material, or as illustrated in FIG. 18b that is in the same plane as the bottom surface 90 of the gelastic material 10. That bottom layer 150 has a thickness TH1. The bottom layer 150 can provide additional support to the gelastic cushion 10. Adding the bottom layer 150 can be easily accomplished in the molding process by merely adding sufficient gelastic material over the components' 102 top surface 104 (see FIG. 9) to a desired thickness, which is TH1. Alternatively, the molding process can have an indentation in certain areas of the mold components 102 for skin layer to have the desired thickness or just overflow the mold so the skin layer obtains the desired thickness.

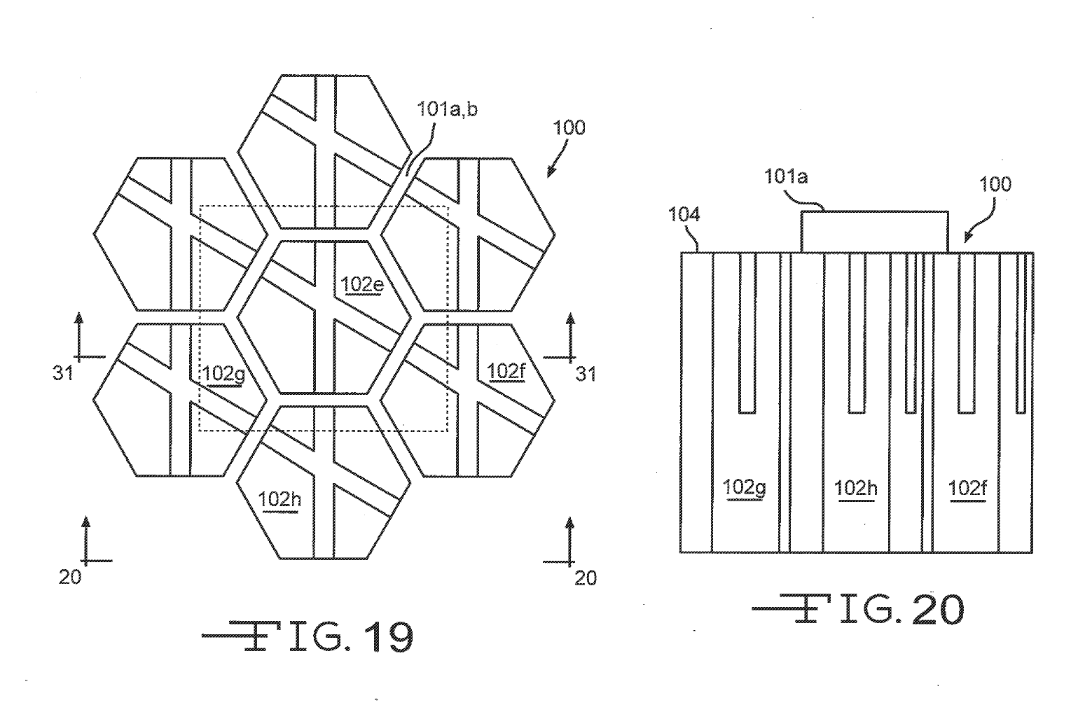

It should be noted that the bottom layer 150 can be positioned at certain desired bottom 90 areas of the gelastic cushion 20 or the entire bottom 90 area. The former embodiment can be accomplished by adding an excess mold component 101a on the mold components 102e-f as illustrated at FIGS. 19 and 20, or an indentation 101b in the mold components 120e-f as illustrated at FIGS. 19 and 24 to desired area of the top surface 104 of the mold components 120 to allow the manufacturer to add additional gelastic material to that certain area and not others. In the embodiment illustrated, the extra material is referred to as a skin layer or a bottom layer 150.

Connectors and/or Apertures

The bottom layer 150 can have apertures 152 as illustrated in FIGS. 18a and 18b. Those apertures 152 can be formed in the molding process and/or by insertion of connectors 154 through the bottom layer 150. The connectors 154 connect the gelastic cushion 10 to a desired apparatus 156—another cushion (foam, bladders), support frame (furniture like chairs and mattresses, or crib materials), or combinations thereof. The connectors 154 can be metal, plastic or combinations thereof. Examples of connectors 154 include nails, screws, rivets, hooks, loops, or equivalents thereof.

By utilizing the bottom layer 150 with the connectors 154, the present invention does not have the gelastic cushion adhere to a non-woven or other material as done in the prior art. The connectors 154 ensure the gelastic material does not move around with less materials than needed than the prior art method.

### Independent Column Walls

In some embodiments, it is desired that each column wall (for example first wall 20a) is independent from the other column walls (first walls 20b,d) by apertures (or gaps) 112 positioned between the respective column walls as illustrated in FIG. 21. That independence is limited in that the column walls are interconnected to the second wall 22 and/or the third wall 24. The aperture 112 can be any sized aperture so long as the column walls are independent from each other. This embodiment decreases excessive buckling and therefore decreases undesired hammocking effect.

### Tailored Top

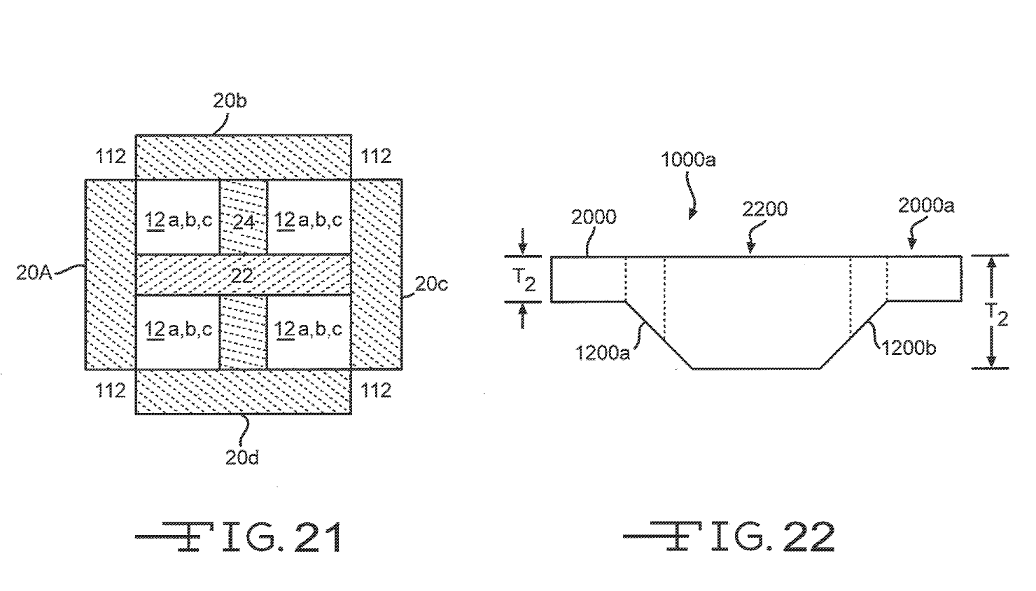

It is well known that a patient normally applies more pressure to a mattress cushion in the seat/thigh area than the foot or the head areas. In view of this information, the applicants have designed a tailored top cushion 1000a as illustrated in FIG. 22. The tailored top cushion 1000a can be described as having at least three cushion zones and two decreased shear gatching areas. The first cushion zone 2000 provides support to a patient's head area, the second zone 2200 provides support to the patient's seat/thigh area, the first decreased shear gatching area 1200a is positioned between the first cushion zone 2000 and the second zone 2200, the third zone 2000a supports the patient's foot area, and the second decreased shear gatching area 1200b is positioned between the third cushion zone 2000a and the second zone 2200.

The second zone 2200 can have a thickness of T1 while the first zone 2000 and the third zone 2000b can have a thickness of T2, which is less than T1. That increased thickness in the second zone 2200 provides increased locations for the second wall 22 and additional walls including the third wall 24 to be positioned within the respective opening areas 12.

The tailor top embodiment is made in the same way as the other gelatinous cushion materials are made. The only exception is that the speed of the molds passing through the extruder pouring the melted gelatinous elastomeric composition is slowed down when the mold has a depth greater the T1 (defined above) to ensure the gelatinous elastomeric composition is a uniform composition throughout the cushion material 1000a. Examples of manufacturing the gelatinous cushion material 1000, 1000a are as follows:

A method for manufacturing a gelatinous elastomer article comprises the steps of: (a) selecting a plasticizer, (b) selecting a triblock copolymer of the general configuration A-B-A that includes SEEPS, (c) premixing said plastizer and said copolymer, (d) using a compounding screw to compound said premixed plasticizer and copolymer, (e) receiving compounded gelatinous elastomer from said screw, (f) optional, permitting said compounded gelatinous elastomer to cool, (g) optional, cutting said cooled compounded gelatinous elastomer into smaller pieces, (h) optional, storing said gelatinous elastomer pieces for a period of time, (i) optional, heating said gelatinous elastomer pieces, and (j) forming said gelatinous elastomer pieces into a desired article. The method entails the further steps of compounding a plasticizer with an SEEPS triblock copolymer or any other desired A-B-A triblock copolymer to form a gelatinous elastomer, and forming said gelatinous elastomer pieces into a desired article; or compounding a plasticizer with the A-B-A triblock copolymer to form molten gelatinous elastomer, forcing molten gelatinous elastomer through an extrusion die, and receiving a formed gelatinous elastomer article from said extrusion die. An alternative method comprises the steps of (a) selecting a plasticizer that includes a plurality of plasticizing polymer molecules, (b) selecting an elastomer comprising a plurality of elastomeric triblock copolymers of the general configuration A-B-A, each of said triblock copolymers having: two end blocks A and one mid block B, and a plurality of hollow spherical objects; wherein each of said mid block B is covalently linked to one of said end blocks A; wherein said end blocks A are non-elastomeric polymers; wherein said mid block B is an elastomeric polymer, wherein said mid block B of at least some of said triblock copolymers includes a plurality of backbone carbon molecules and a plurality of side chains; wherein said elastomer has a weight average molecular weight of at least about 300,000 when determined by gel permeation chromatography; wherein said plasticizing polymer molecules, upon placement of the material under a load, tend to facilitate disentanglement and elongation of said mid blocks B during elongation of the material; wherein said plasticizing polymer molecules, upon release of the load from the material, tend to facilitate recontraction of the material; wherein said plasticizing polymer molecules comprise at least about 60 weight percent of the material, based on the combined weights of said triblock copolymers and said plasticizing polymers; wherein said elastomer has a measurable percent elongation at break; wherein said plasticizer tends to increase the percent elongation at break of said elastomer; wherein said elastomer has a rigidity measurable on the Gram Bloom scale, and wherein said plasticizer tends to decrease the Gram Bloom rigidity of said elastomer; (c) mixing said plasticizer and said triblock copolymer by a method selected from the group consisting of melt blending and use of a compounding screw in order to produce a gelatinous elastomer, (d) permitting said gelatinous elastomer to cool, (e) selecting a forming device, (f) melting said gelatinous elastomer, and (g) using said forming device in order to form said gelatinous elastomer into a desired shape. Alternatively, the heated and mixed homogenous (melt blended, augured, and/or compounding screwed) gelatinous elastomeric material can be immediately poured into a mold without being cooled and re-melted. Forming the gelatinous elastomer material into a desired shape is normally accomplished by pouring the re-melted or originally melted gelatinous elastomer material into a mold or equivalent thereof.

When the tailor top configuration is used on a gatch bed frame, the seat/thigh section that receives the T2 section of the tailor top configuration is positioned lower than the head and foot sections so the cushion's entire top surface is in the same plane when the gatch bed frame is in its “horizontal position”.

The example illustrated in FIG. 1 shows first walls in a rectangular shape which includes a square and a diamond shape (a rotated square). The first walls can be any shape including circles, pentagons, hexagons (as alluded to in FIGS. 8 and 9), n-sided polygonic shape, or any other desired shape that will allow the first wall and the second wall (and possible other walls) to buckle as desired.

FIGS. 8 and 9 illustrate four components 102a,b,c,d of a mold 100 that form an embodiment of the gelastic cushion 10 having multiple heights buckling walls within and surrounding an opening area. The mold 100 is a conventional mold having components that can withstand the gelastic material in a molten state. That material can be metal, polymeric and/or combinations thereof.

The mold 100 as illustrated in FIG. 8 shows four components 102a,b,c,d, in a hexagonal shape. The gelastic material is poured onto the mold 100 and the gelastic material that falls within (a) the gaps 120 form the first walls 20, (b) the gaps 122 form the second walls 22 and (c) the gaps 124 form the third walls 24. FIG. 8 illustrates the top of the mold 100, which illustrates the gelastic cushion's bottom surface 90.

FIG. 9 illustrates component 102a and a portion of component 102d from arrow 9 in FIG. 8. As alluded by FIGS. 2 to 9, the first wall 20 is defined by (a) the gap 120 positioned between the various components 102 a,b,c,d and (b) a bottom surface 190 of the mold 100 (the top 90 of the gelastic material 10). In contrast the second wall 22 is defined entirely by the gap 122 in each component 102, and the third wall 24 is defined entirely by the gap 124 in each component 102.

As illustrated in FIGS. 3, 5, and 7, the second wall 22 has a top surface 42 that is level and the third wall 24 has a top surface 44 that is level. Those top surfaces 42, 44 can also be concave, convex, level or combinations thereof. Examples, and not limitations, of those embodiments are illustrated in FIGS. 10 to 17. Those alternative embodiments for the top surfaces 42, 44 can be defined by altering the shape in the gaps 122, 124 in each component. It is well known that concave, convex and level top surfaces can strengthen, weaken or maintain the present support of the first wall 20, the second wall 22 and/or the third wall 24. By having various shaped top surfaces 42, 44 in different portions of the gelastic cushion, the gelastic cushion 10 can have various levels of support provided by the various walls 20, 22, 24 throughout the gelastic cushion 10.

### Alternative Uses

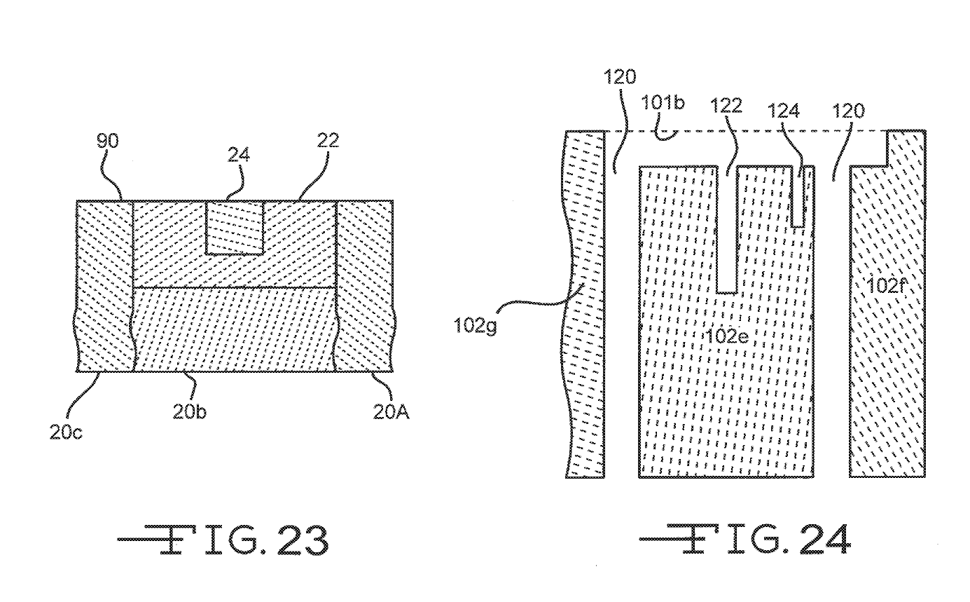

The present gelastic cushion material can be flipped over when used. By flipped over, the above-identified bottom layer 90 becomes the layer that the patient contacts. That way the present gelastic cushion material has increased surface area applied to the patient which can decrease the pressure applied to the patient. When the cushion material is flipped over, as illustrated in FIG. 23, the first wall, the second wall and the third wall buckle in the same way as described and illustrated above, except upside down.

### Filler

The gelastic cushion material can have filler positioned within the opening areas 12. The filler can be a fluid like water or an aqueous liquid, a gel material, bead material like polyethylene beads, down, horsehair, and combinations thereof. The filler, depending on the material selected, can strengthen, maintain, or weaken the gelastic walls material.

### Adjusting Wall Strength

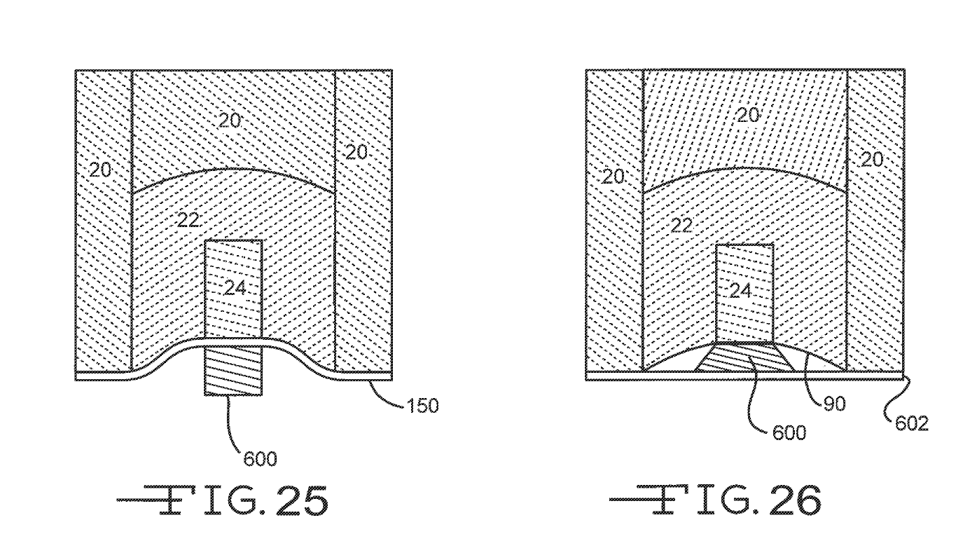

If the embodiment with a skin layer 150 is used, the walls 20, 22, 24 of the present gelastic cushion material can be strengthened by positioning a peg 600, as illustrated in FIG. 25 under the skin layer 150. Depending on the size of the peg 600, the gelastic cushion material's walls can be strengthened by pulling the walls closer together when the skin layer 150 is positioned over the peg 600. The peg 600 can be any material like wood, gelastic material, metallic, polymeric or combinations thereof.

Alternatively, the peg 600 can be positioned below a gelastic material without any skin layer 150 but having the peg positioned below the first wall 20, the second wall 22, the third wall 24 or combinations thereof.

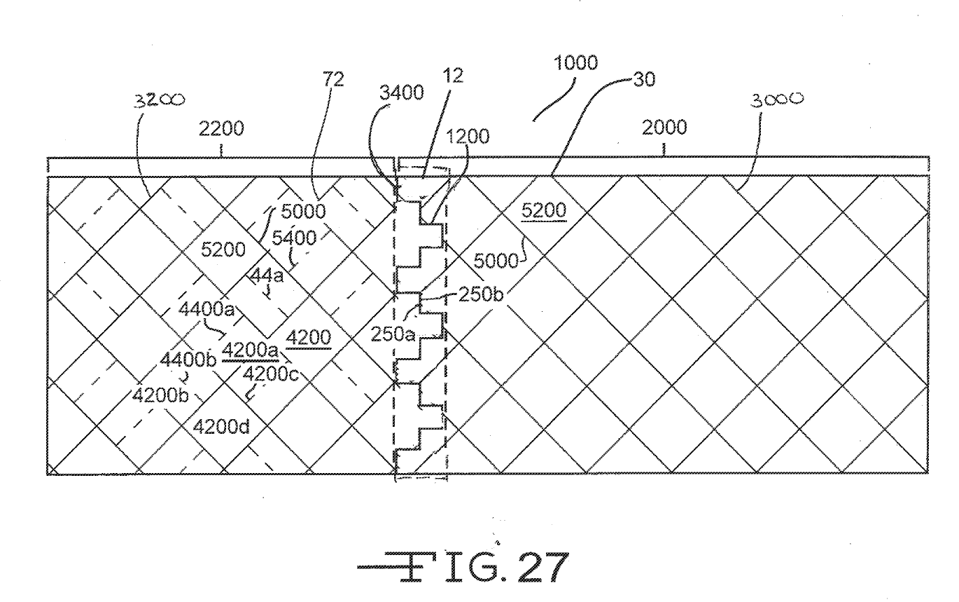

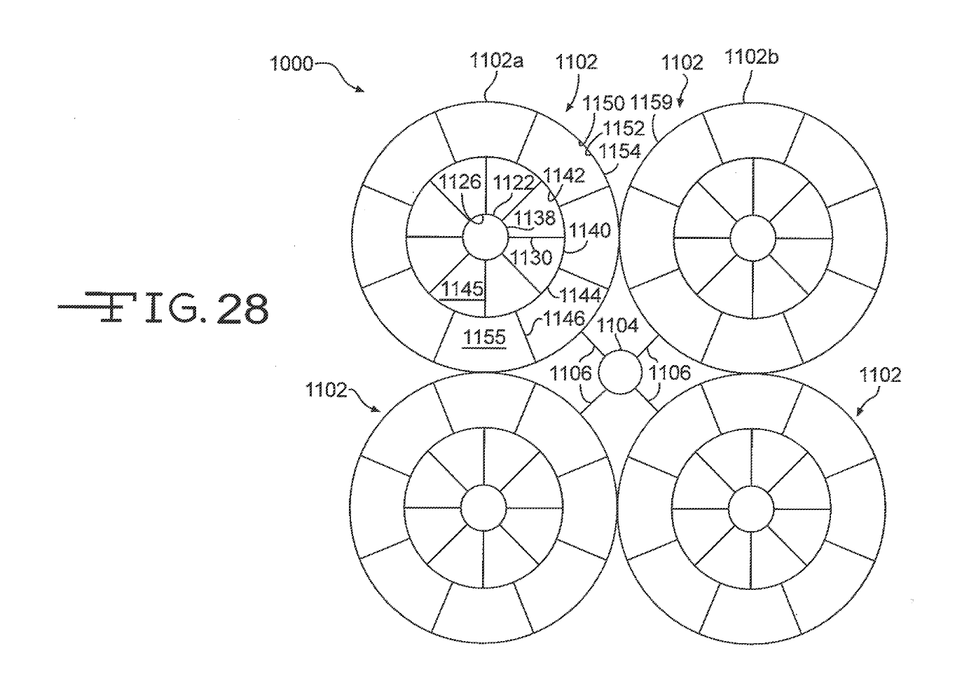

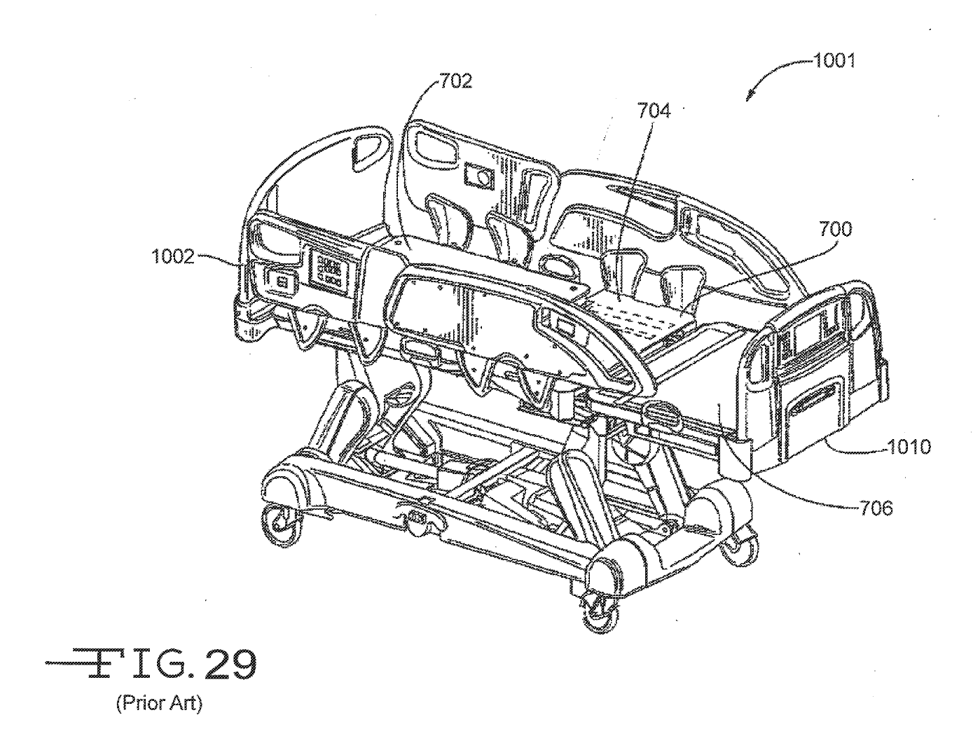

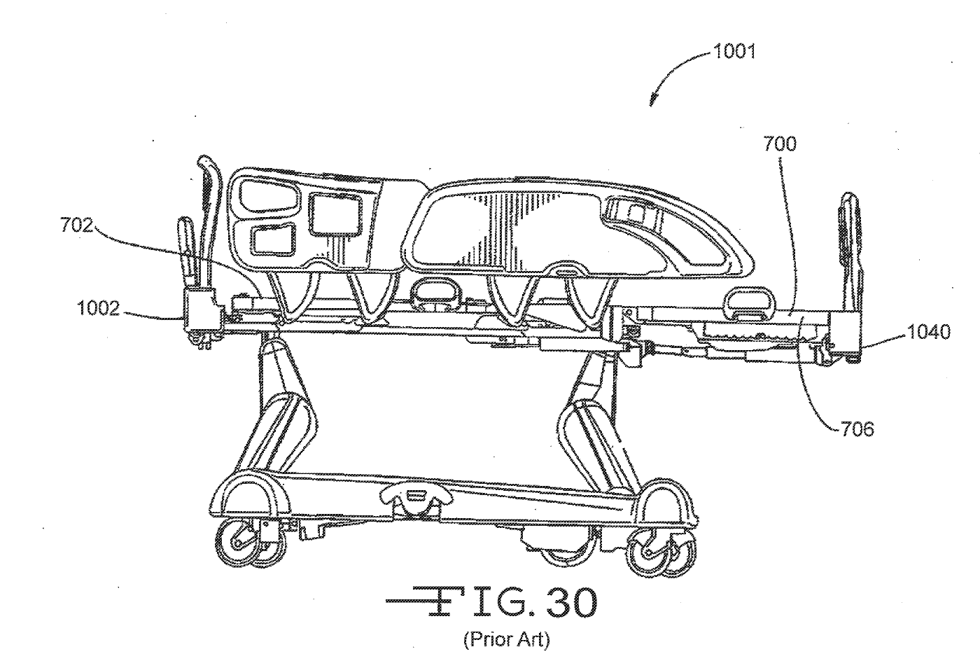

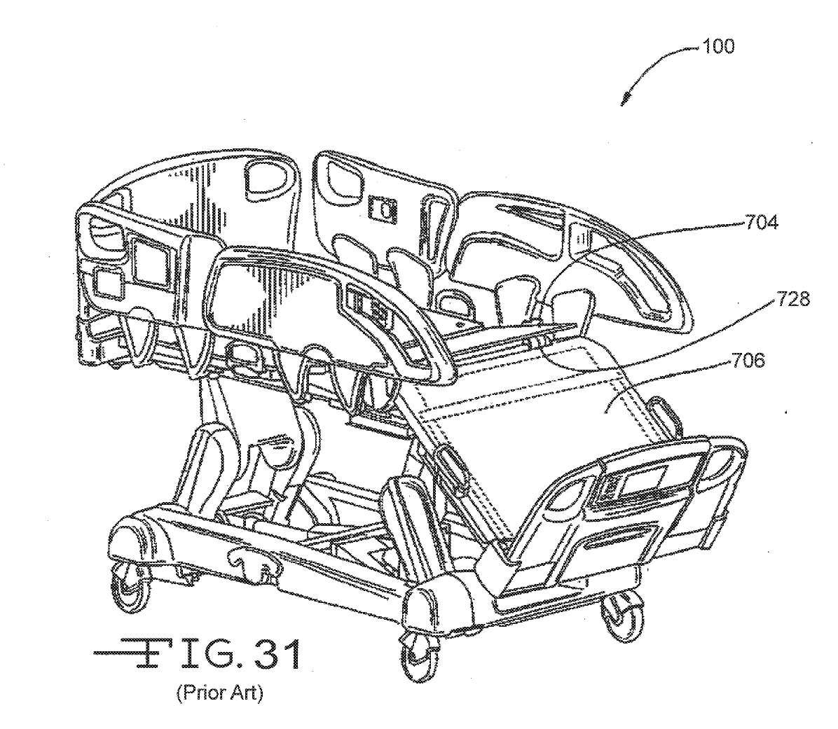

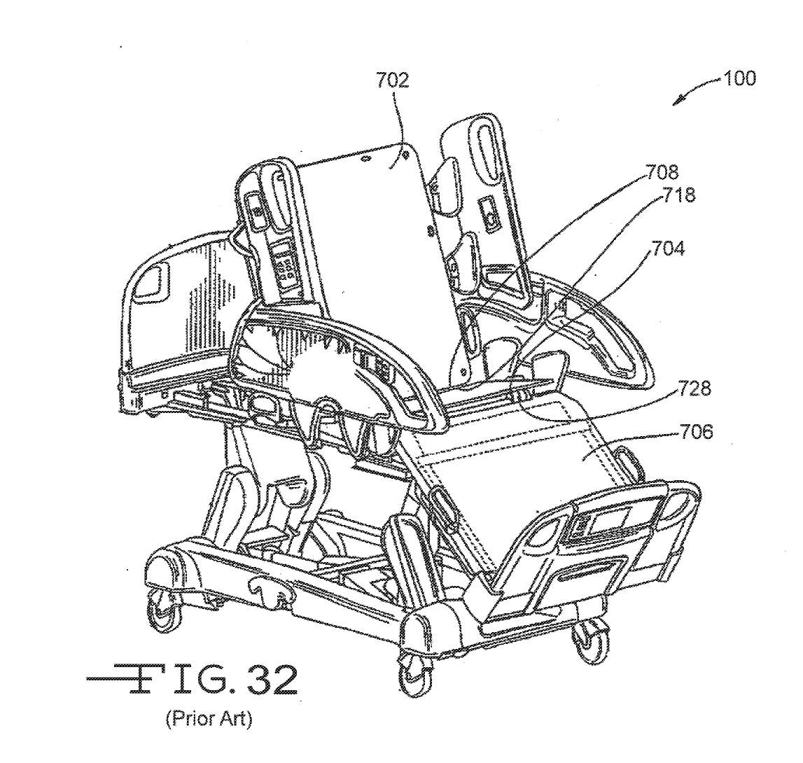

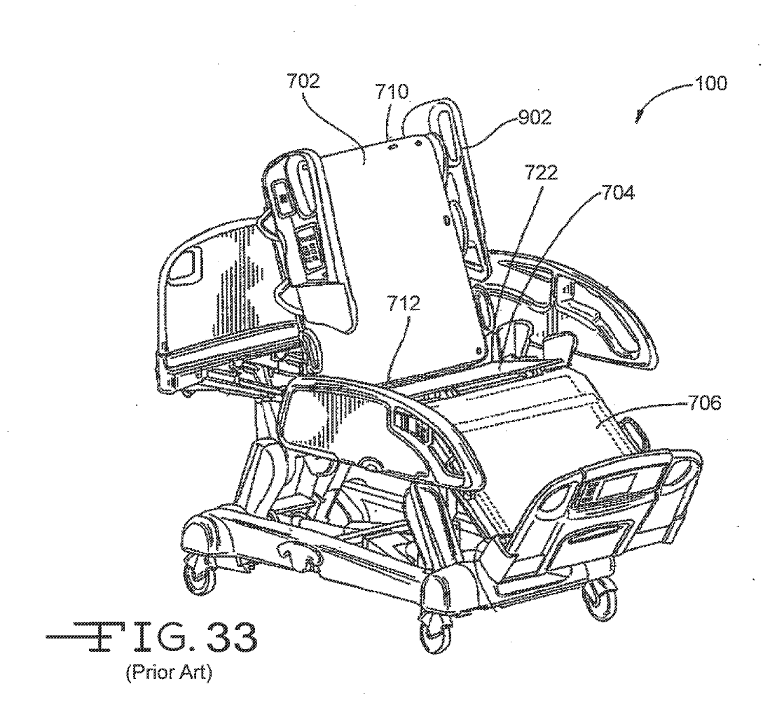

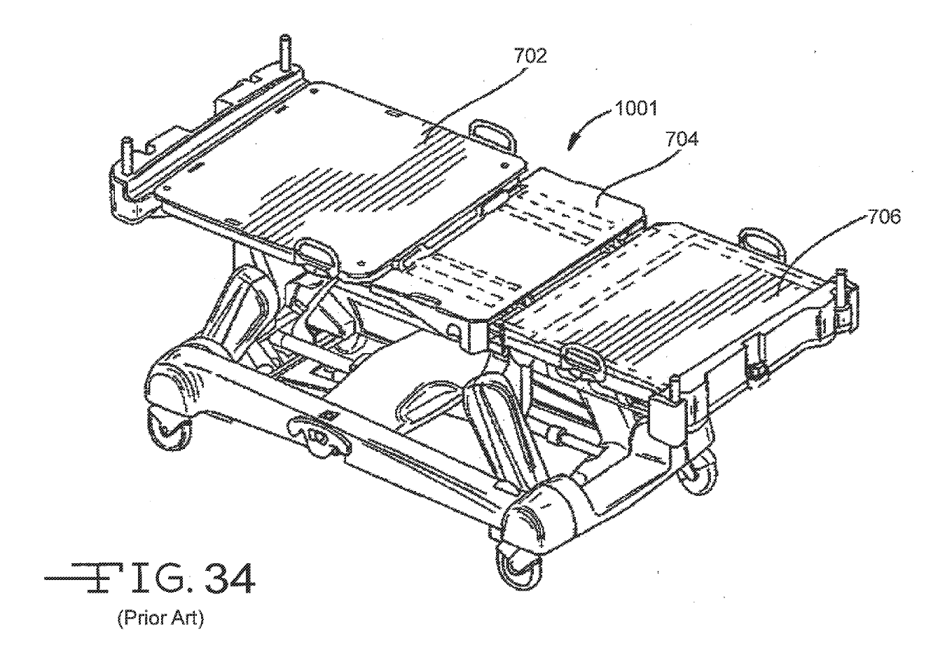

Another embodiment of using the peg 600 is illustrated at FIG. 26, the peg 600 material can be positioned on and attached to a non-woven material 602 or equivalent thereof. The non-woven material 602 with the peg 600 material can be positioned below the gelastic material and/or attached to the bottom surface 90 of the gelastic material. One example in which the non-woven can be attached to the gelastic cushion is by ironing (heating) the non-woven material to the gelastic material.

Another embodiment of the present invention occurs when different sized and/or shaped pegs are positioned below certain locations of the gelastic material in order to strengthen some areas and not others. This embodiment is a variation of the embodiments illustrated in FIGS. 25 and 26 but with more pegs of different shapes and/or sizes for different areas of the gelastic material.

It is intended that the above description of the preferred embodiments of the structure of the present invention and the description of its operation are but one or two enabling best mode embodiments for implementing the invention. Other modifications and variations are likely to be conceived of by those skilled in the art upon a reading of the preferred embodiments and a consideration of the appended claims and drawings. These modifications and variations still fall within the breadth and scope of the disclosure of the present invention.

We claim:

1. A gelatinous elastomeric material comprising:
a first gelatinous elastomeric cushion section (a) made of a first A-B-A triblock copolymer and a first plasticizer, (b) having a first gelatinous elastomeric wall (i) in a first columned gelatinous elastomeric configuration, (ii) as the highest wall in a first multi-height gelatinous elastomeric hollow columned configuration, (iii) a first decreased pressure point multi-height gelatinous elastomeric configuration, (iv) an alternative decreased pressure point multi-height gelatinous elastomeric configuration, or (v) combinations thereof, and (c) has the first gelatinous elastomeric wall having a first top surface, a first bottom surface and two first side surfaces, wherein the side surfaces are in a first direction;
a second gelatinous elastomeric cushion section (a) made of a second A-B-A triblock copolymer and a second plasticizer, (b) having a second gelatinous elastomeric wall (i) in a second columned gelatinous elastomeric configuration, (ii) as the highest wall in a second multi-height gelatinous elastomeric hollow columned configuration, (iii) a second decreased pressure point multi-height gelatinous elastomeric configuration, (iv) an alternative decreased pressure point multi-height gelatinous elastomeric configuration, or (v) combinations thereof, and (c) has the second gelatinous elastomeric wall having a second top surface, a second bottom surface and two second side surfaces, wherein the second side surfaces are in a second direction;
a first decreased shear gatching area (a) positioned between the first gelatinous elastomeric cushion section and the second gelatinous elastomeric cushion section, (b) made of a third A-B-A triblock copolymer and a third plasticizer, (c) having a third gelatinous elastomeric wall (i) in a third columned gelatinous elastomeric configuration, (ii) as the highest wall in a third multi-height gelatinous elastomeric hollow columned configuration, (iii) a third decreased pressure point multi-height gelatinous elastomeric configuration, (iv) in a step pyramid configuration, (v) an alternative decreased pressure point multi-height gelatinous elastomeric configuration, or (vi) combinations thereof, (d) has a third gelatinous elastomeric wall having a third top surface, a third bottom surface, a first third side surface and a second third side surface, (e) has the first gelatinous elastomeric wall connected to the first third side surface positioned on the third gelatinous elastomeric wall's distal end wherein the third gelatinous elastomeric wall's distal end is at an angle offset from the direction of the first gelatinous elastomeric wall; and (f) has the second gelatinous elastomeric wall connected to the second third side surface positioned on the third gelatinous elastomeric wall's proximal end wherein the third gelatinous elastomeric wall's proximal end is at an angle offset from the direction of the second gelatinous elastomeric wall.

2. The gelatinous elastomeric material of claim 1 wherein the first direction and the second direction are the same.

3. The gelatinous elastomeric material of claim 1 wherein the decreased shear gatching area positioned, the first gelatinous elastomeric cushion section and the second gelatinous elastomeric cushion section have the same A-B-A triblock copolymer and plasticizer.

4. The gelatinous elastomeric material of claim 1 further comprising:
a third gelatinous elastomeric cushion section (a) made of a fourth A-B-A triblock copolymer and a fourth plasticizer, (b) having a fourth gelatinous elastomeric wall (i) in a fourth columned gelatinous elastomeric configuration, (ii) as the highest wall in a fourth multi-height gelatinous elastomeric hollow columned configuration, (iii) a fourth decreased pressure point multi-height gelatinous elastomeric configuration, (iv) an alternative decreased pressure point multi-height gelatinous elastomeric configuration, or (v) combinations thereof, and (c) has the fourth gelatinous elastomeric wall having a fourth top surface, a fourth bottom surface and two fourth side surfaces, wherein the side surfaces are in a third direction;
a second decreased shear gatching area (a) positioned between the third gelatinous elastomeric cushion section and the second gelatinous elastomeric cushion section, (b) made of a fifth A-B-A triblock copolymer and a fifth plasticizer, (c) having a fifth gelatinous elastomeric wall (i) in a fifth columned gelatinous elastomeric configuration, (ii) as the highest wall in a fifth multi-height gelatinous elastomeric hollow columned configuration, (iii) a fifth decreased pressure point multi-height gelatinous elastomeric configuration, (iv) in a second step pyramid configuration, (v) an alternative decreased pressure point multi-height gelatinous elastomeric configuration, or (vi) combinations thereof, (d) has a fifth gelatinous elastomeric wall having a fifth top surface, a fifth bottom surface, a first fifth side surface and a second fifth side surface, (e) has the second gelatinous elastomeric wall connected to the first fifth side surface positioned on the fifth gelatinous elastomeric wall's distal end wherein the fifth gelatinous elastomeric wall's distal end is at an angle offset from the direction of the second gelatinous elastomeric wall; and (f) has the fourth gelatinous elastomeric wall connected to the second fifth side surface positioned on the fifth gelatinous elastomeric wall's proximal end wherein the fifth gelatinous elastomeric wall's proximal end is at an angle offset from the direction of the fourth gelatinous elastomeric wall.

5. The gelatinous elastomeric material of claim 4 wherein the third gelatinous elastomeric cushion section, the second decreased shear gatching area, the second gelatinous elastomeric cushion section, the decreased shear gatching area, and the first gelatinous elastomeric cushion section form a tailored top configuration.

6. The gelatinous elastomeric material of claim 4 wherein the gelatinous elastomeric material is positioned on a three-section gatching bed frame having a first pivot area positioned between a head section and a seat/thigh section and a second pivot area positioned between the seat/thigh section and a foot area and the first decreased shear gatching area is positioned over the first pivot area and the second decreased shear gatching area is positioned over the second pivot area.

7. The gelatinous elastomeric material of claim 5 wherein the gelatinous elastomeric material is positioned on a three-section gatching bed frame having a first pivot area positioned between a head section and a seat/thigh section and a second pivot area positioned between the seat/thigh section and a foot area and the first decreased shear gatching area is positioned over the first pivot area and the second decreased shear gatching area is positioned over the second pivot area.

8. The gelatinous elastomeric material of claim 1 wherein the gelatinous elastomeric material is positioned on a two-section gatching bed frame having a first pivot area positioned between a head section and a seat/thigh/foot section and the first decreased shear gatching area is positioned over the first pivot area.

9. The gelatinous elastomeric material of claim 1 wherein the gelatinous elastomeric material is positioned on a two-section gatching bed frame having a first pivot area positioned between a head/seat/thigh section and a foot section and the first decreased shear gatching area is positioned over the first pivot area.

10. The gelatinous elastomeric material of claim 1 wherein the first, the second, the third, the fourth and/or the fifth multi-height gelatinous elastomeric hollow columned configuration has
A. a first set of buckling walls
(i) define a first opening area,
(ii) are the tallest walls in the gelastic cushion with a first height ranging from the first set of the buckling walls' bottom surface to the first set of buckling walls' top surface,
(iv) have a first width that allows the first set of buckling walls to buckle, when a force is applied at the first set of buckling walls' top surface to the first set of buckling walls, into the first opening area or into
(a) an adjacent second opening and/or
(b) exterior to the perimeter of the gelastic cushion;
B. a second wall
(i) positioned within the first opening area,
(ii) interconnects to
(a) a first interconnection area that extends from the first set of buckling walls' bottom surface a distance greater than zero along the first wall toward the first set of buckling walls' top surface and
(b) a second interconnection point area that extends from the first set of buckling walls' bottom surface a distance greater than zero along the first wall toward the first set of buckling walls' top surface wherein the first interconnection area is diametrical to the second interconnection area;
(iii) has a second height, which is less than the first height of the first set of buckling walls and the difference between the first height of the first set of buckling walls and second height of the second wall is a first differential distance;
(iv) has a second width that allows the second wall to buckle into the first opening area if the force applied to the first set of buckling walls buckles the first set of buckling walls a distance greater than the first differential distance.

11. A gelastic cushion comprising:
a triblock polymer of the general configuration A-B-A and a plasticizer formed into a gelastic cushion having at least a section having a decreased pressure point multi-height gelatinous elastomeric hollow columned configuration;
the decreased pressure point multi-height gelatinous elastomeric hollow columned configuration has
A. a first set of buckling walls
(i) define a first opening area,
(ii) are the tallest walls in the decreased pressure point multi-height gelatinous elastomeric hollow columned configuration section with a first height ranging from the first set of the buckling walls' bottom surface to the first set of buckling walls' top surface,
(iii) have a first width that allows the first set of buckling walls to buckle, when a force is applied at the first set of buckling walls' top surface to the first set of buckling walls, into the first opening area or into
(a) an adjacent second opening and/or
(b) exterior to the perimeter of the gelastic cushion;
B. a second wall
(i) positioned within the first opening area,
(ii) interconnects to
(a) a first interconnection area that extends from the first set of buckling walls' bottom surface a distance greater than zero toward the first set of buckling walls' top surface and
(b) a second interconnection area that extends from the first set of buckling walls' bottom surface a distance greater than zero toward the first set of buckling walls' top surface wherein the first interconnection area is diametrical to the second interconnection area;
(iii) has a second height, which is less than the first height of the first set of buckling walls and the difference between the first height of the first set of buckling walls and second height of the second wall is a first differential distance;
(iv) has a second width that allows the second wall to buckle into the first opening area if the force applied to the first set of buckling walls buckles the first set of buckling walls a distance greater than the first differential distance;
C. a second set of buckling walls
(i) define the second opening area,
(ii) are the tallest walls in the decreased pressure point multi-height gelatinous elastomeric hollow columned configuration section with a second height ranging from the second set of the buckling walls' bottom surface to the second set of buckling walls' top surface,
(iii) have the first width that allows the second set of buckling walls to buckle, when a force is applied at the second set of buckling walls' top surface to the second set of buckling walls, into the second opening area or into
(a) an adjacent third opening,
(b) the adjacent first opening, and/or
(c) exterior to the perimeter of the gelastic cushion;
D. a third wall
(i) positioned within the second opening area,
(ii) interconnects to
(a) a third interconnection area that extends from the second set of buckling walls' bottom surface a distance greater than zero toward the second set of buckling walls' top surface and
(b) a fourth interconnection area that extends from the second set of buckling walls' bottom surface a distance greater than zero toward the second set of buckling walls' top surface wherein the third interconnection area is diametrical to the fourth interconnection area and the third wall is not in the same plane as the second wall;
(iii) has the second height, which is less than the first height of the second set of buckling walls and the difference between the first height of the second set of buckling walls and second height of the second wall is the first differential distance;
(iv) has a second width that allows the second wall to buckle into the second opening area if the force applied to the second set of buckling walls buckles the second set of buckling walls a distance greater than the first differential distance.

12. The gelastic cushion of claim 11 wherein the second wall and the third wall are orthogonal to each other.

13. The gelastic cushion of claim 11 wherein there is no second wall in the third opening area formed from a third set of buckling walls.

14. The gelastic cushion of claim 11 wherein the first opening area and, the second opening area share a common wall.

15. A gelastic cushion comprising:
a triblock polymer of the general configuration A-B-A and a plasticizer formed into a gelastic cushion having at least a section having a first decreased pressure point multi-height gelatinous elastomeric hollow columned configuration;
the first decreased pressure point multi-height gelatinous elastomeric hollow columned configuration has
A. a first circular gelatinous buckling wall
(i) defining a first opening area,
(ii) has a first width that allows the circular buckling wall to buckle, when a force is applied at the first circular buckling wall's top surface to the first circular buckling wall, into the first opening area or into an adjacent second opening;
B. a second circular gelatinous buckling wall
(i) defining a second opening area between the first circular buckling wall and the second circular buckling wall,
(ii) has the first width that allows the second circular buckling wall to buckle, when a force is applied at the second circular buckling wall's top surface to the second circular buckling wall, into the second opening area or into a third opening area;
C. a third circular gelatinous buckling wall
(i) defining a third opening area between the second circular buckling wall and the third circular buckling wall,
(ii) has the first width that allows the third circular buckling wall to buckle, when a force is applied at the third circular buckling wall's top surface to the third circular buckling wall, into the second opening area, a fourth opening area or exterior to the perimeter of the gelastic cushion;
D. a first plurality of spoke gelatinous buckling walls that interconnect the first circular buckling wall to the second circular buckling wall and are interspaced throughout the first opening area;
E. a second plurality of spoke gelatinous buckling walls that interconnect the third circular buckling wall to the second circular buckling wall, are interspaced throughout the second opening area and wherein the first set of spoke walls and the second set of spoke walls are misaligned to not form a straight line.

16. The gelatinous cushion of claim 15 wherein a second decreased pressure point multi-height gelatinous elastomeric hollow columned configuration is connected to the first decreased pressure point multi-height gelatinous elastomeric hollow columned configuration.

17. The gelatinous cushion of claim 16 wherein the first decreased pressure point multi-height gelatinous elastomeric hollow columned configuration's exterior surface has a first gelatinous buckling interconnection wall extending toward and attaching to a gelatinous buckling interconnection device, and the second decreased pressure point multi-height gelatinous elastomeric hollow columned configuration's exterior surface has a second gelatinous buckling interconnection wall extending toward and attaching to the gelatinous buckling interconnection device wherein the first and the second gelatinous buckling interconnection walls are not aligned with the spoke walls that contact the decreased pressure point multi-height gelatinous elastomeric hollow columned configuration's exterior wall.

18. A method to produce a gelastic cushion comprising:
A. selecting a mold material;
B. cutting the mold material to create a gelastic structure having
a first gelatinous elastomeric cushion section (a) made of a first A-B-A triblock copolymer and a first plasticizer, (b) having a first gelatinous elastomeric wall (i) in a first columned gelatinous elastomeric configuration, (ii) as the highest wall in a first multi-height gelatinous elastomeric hollow columned configuration, (iii) a first decreased pressure point multi-height gelatinous elastomeric configuration, (iv) an alternative decreased pressure point multi-height gelatinous elastomeric configuration, or (v) combinations thereof, and (c) has the first gelatinous elastomeric wall having a first top surface, a first bottom surface and two first side surfaces, wherein the side surfaces are in a first direction;
a second gelatinous elastomeric cushion section (a) made of a second A-B-A triblock copolymer and a second plasticizer, (b) having a second gelatinous elastomeric wall (i) in a second columned gelatinous elastomeric configuration, (ii) as the highest wall in a second multi-height gelatinous elastomeric hollow columned configuration, (iii) a second decreased pressure point multi-height gelatinous elastomeric configuration, (iv) an alternative decreased pressure point multi-height gelatinous elastomeric configuration, or (v) combinations thereof, and (c) has the second gelatinous elastomeric wall having a second top surface, a second bottom surface and two second side surfaces, wherein the second side surfaces are in a second direction;
a first decreased shear gatching area (a) positioned between the first gelatinous elastomeric cushion section and the second gelatinous elastomeric cushion section, (b) made of a third A-B-A triblock copolymer and a third plasticizer, (c) having a third gelatinous elastomeric wall (i) in a third columned gelatinous elastomeric configuration, (ii) as the highest wall in a third multi-height gelatinous elastomeric hollow columned configuration, (iii) a third decreased pressure point multi-height gelatinous elastomeric configuration, (iv) in a step pyramid configuration, (v) an alternative decreased pressure point multi-height gelatinous elastomeric configuration, or (vi) combinations thereof, (d) has a third gelatinous elastomeric wall having a third top surface, a third bottom surface, a first third side surface and a second third side surface, (e) has the first gelatinous elastomeric wall connected to the first third side surface positioned on the third gelatinous elastomeric wall's distal end wherein the third gelatinous elastomeric wall's distal end is at an angle offset from the direction of the first gelatinous elastomeric wall; and (f) has the second gelatinous elastomeric wall connected to the second third side surface positioned on the third gelatinous elastomeric wall's proximal end wherein the third gelatinous elastomeric wall's proximal end is at an angle offset from the direction of the second gelatinous elastomeric wall;
C. pouring a gelastic material into the mold to form the gelastic cushion.

19. The method of claim 18 further comprising cutting the mold material to create the gelastic structure having
a third gelatinous elastomeric cushion section (a) made of a fourth A-B-A triblock copolymer and a fourth plasticizer, (b) having a fourth gelatinous elastomeric wall (i) in a fourth columned gelatinous elastomeric configuration, (ii) as the highest wall in a fourth multi-height gelatinous elastomeric hollow columned configuration, (iii) a fourth decreased pressure point multi-height gelatinous elastomeric configuration, (iv) an alternative decreased pressure point multi-height gelatinous elastomeric configuration, or (v) combinations thereof, and (c) has the fourth gelatinous elastomeric wall having a fourth top surface, a fourth bottom surface and two fourth side surfaces, wherein the side surfaces are in a third direction;
a second decreased shear gatching area (a) positioned between the third gelatinous elastomeric cushion section and the second gelatinous elastomeric cushion section, (b) made of a fifth A-B-A triblock copolymer and a fifth plasticizer, (c) having a fifth gelatinous elastomeric wall (i) in a fifth columned gelatinous elastomeric configuration, (ii) as the highest wall in a fifth multi-height gelatinous elastomeric hollow columned configuration, (iii) a fifth decreased pressure point multi-height gelatinous elastomeric configuration, (iv) in a second step pyramid configuration, (v) an alternative decreased pressure point multi-height gelatinous elastomeric configuration, or (vi) combinations thereof, (d) has a fifth gelatinous elastomeric wall having a fifth top surface, a fifth bottom surface, a first fifth side surface and a second fifth side surface, (e) has the second gelatinous elastomeric wall connected to the first fifth side surface positioned on the fifth gelatinous elastomeric wall's distal end wherein the fifth gelatinous elastomeric wall's distal end is at an angle offset from the direction of the second gelatinous elastomeric wall; and (f) has the fourth gelatinous elastomeric wall connected to the second fifth side surface positioned on the fifth gelatinous elastomeric wall's proximal end wherein the fifth gelatinous elastomeric wall's proximal end is at an angle offset from the direction of the fourth gelatinous elastomeric wall.

20. The method of claim 19 wherein the third gelatinous elastomeric cushion section, the second decreased shear gatching area, the second gelatinous elastomeric cushion section, the decreased shear gatching area, and the first gelatinous elastomeric cushion section form a tailored top configuration wherein the pouring step is slowed down when pouring the area applied to the thicker area of the tailored top configuration.
